(19) United States
(12) Patent Application Publication
(10) Pub. No.: US 2025/0342530 A1
(43) Pub. Date: Nov. 6, 2025

(54) DIGITAL ENTITLEMENT CREATION, DISTRIBUTION, SOCIAL MANAGEMENT, AND REDEMPTION SYSTEM

(71) Applicant: Dropness LLC, San Jose, CA (US)

(72) Inventors: Hieu Trung Tran, San Jose, CA (US); Thomas Irving Sachson, Malibu, CA (US)

(21) Appl. No.: 19/197,766

(22) Filed: May 2, 2025

Related U.S. Application Data
(60) Provisional application No. 63/642,062, filed on May 3, 2024.
(60) Provisional application No. 63/644,009, filed on May 8, 2024.
(60) Provisional application No. 63/648,639, filed on May 16, 2024.
(60) Provisional application No. 63/670,237, filed on Jul. 12, 2024.

(51) Int. Cl. G06Q 40/04; G06Q 20/36

(52) U.S. Cl. CPC G06Q 40/0431; G06Q 20/36; G06Q 40/0421; G06Q 40/055

(57) ABSTRACT

Tokenization, social distribution, and redemption of digital entitlements, including: a digital entitlement ingestion and tokenization engine configured to receive and escrow value-bearing digital entitlements from an entity; a token engine configured to generate transferable tokens from the entitlements with embedded redemption rules; a distribution module enabling third-party entities to purchase and airdrop the tokens to end users based on location or contextual triggers; a user wallet interface enabling the end users to collect, store, gift, and redeem the tokens; a social gifting module configured to allow the end users to transmit the tokens to other users subject to transfer rules; and an optional redemption bridge configured to un-tokenize the tokens that have been redeemed and initiate value transfer to accounts of the end users within the originating system.

### CROSS-REFERENCE TO RELATED APPLICATIONS

This application claims the benefits of priority under 35 U.S.C. § 119(e) of: co-pending U.S. Provisional Patent Application No. 63/642,062, filed May 3, 2024, entitled “Tokenized Digital Asset Creation, Distribution, Management, and Redemption System”; co-pending U.S. Provisional Patent Application No. 63/644,009, filed May 8, 2024, entitled “System and Method for Providing Digital Rewards to Delayed Travelers at Transportation Hubs”; co-pending U.S. Provisional Patent Application No. 63/648,639, filed May 16, 2024, entitled “Hyper-Accurate Location-Based Targeting and Anonymous Interaction System for Mobile Devices”; and co-pending U.S. Provisional Patent Application No. 63/670,237, filed Jul. 12, 2024, entitled “Method & System for Tokenized Music Streaming Points Distribution and User-Generated Content Engagement”. The disclosures of the above-referenced applications are incorporated herein by reference.

### BACKGROUND

### Field

The present disclosure relates generally to systems and methods for the tokenization, distribution, management, and redemption of digital entitlements. More specifically, it pertains to a unified platform enabling brands, organizations, and digital asset holders to convert disparate value-bearing assets.

### Background

Over the past two decades, digital entitlements have become a foundational component of consumer engagement across numerous industries. These entitlements include, but are not limited to, loyalty points, promotional codes, digital credits, paywalled access tokens, airline miles, virtual goods, game-based currencies, and blockchain-based assets such as NFTs and cryptocurrencies. While each system grants users a form of value, implementations of these entitlements remain largely proprietary, inflexible, and siloed. Consumers are unable to easily consolidate, trade, gift, or rediscover value across these systems in a manner that reflects the fluidity and connectivity of modern digital behavior.

At present, most digital entitlement ecosystems suffer from four critical constraints:

Closed Architecture: Each entitlement type is generally issued and managed within a brand-specific or platform-specific environment. Airline miles, for instance, are typically trapped within a frequent flyer program; promo codes are valid only within narrowly scoped retail checkouts; and NFTs are often bound to a particular smart contract or game logic. There is no standardized system that allows these assets to move freely between platforms—and, most importantly, between users—without compromising security or brand control.

Lack of Commercial Interoperability: The issuance of digital entitlements is typically treated as a cost center—a tool to drive retention or behavior—but rarely as a source of direct revenue. Brands do not currently monetize their loyalty points or promo codes by selling them to other brands for redistribution. As a result, these assets are underutilized, expire unused, or remain invisible to potential new customer acquisition strategies.

Minimal Social Context: Most entitlement systems fail to reflect how people interact with value in modern digital culture. Consumers routinely share, recommend, gift, and re-gift experiences—yet are often unable to do the same with digital entitlements they possess. Even in systems that allow limited transfer, there is typically no way to control visibility, request assets from trusted peers, or selectively broadcast dormant entitlements to a defined social graph. This lack of social sharing and endorsement prevents platforms from collecting valuable interpersonal connection and preference data. For instance, a user who hoards digital entitlements may signal high personal valuation, while a user who freely gifts them may be indicating that the item is not valuable to them personally—yet potentially valuable to the recipient. This pattern is highly informative for both brands and platforms seeking to understand intent and affinity.

No Mechanism for Recycling Brand Advertising Spend: In the current digital advertising ecosystem, a brand's investment in promotions or engagement campaigns yields either a successful interaction or a static loss. There is no propagation effect. However, with tokenized digital entitlements distributed via social gifting and regifting in a frictionless, permissioned ecosystem, the promotional value may persist across multiple user interactions. Each handoff—from original recipient to secondary and tertiary recipients—functions as a recycled instance of brand exposure until the entitlement reaches a user who finds it personally valuable and retains it. This creates a cascading engagement model in which brand investments are extended and amplified, rather than consumed in a single transaction.

Simultaneously, the rise of Gen Z and digital-native consumers has introduced new expectations around user agency, the mobility of value, and the fusion of entertainment, commerce, and social connectivity. These consumers expect digital assets to be portable, personal, and shareable—regardless of their source. Yet no platform currently allows digital entitlements to flow seamlessly across commercial, social, and experiential contexts while preserving embedded redemption logic and respecting data privacy frameworks.

Attempts to address these limitations using Web3 protocols have often leaned too heavily on speculative token economies, decentralized infrastructures, or unregulated smart contract interactions—all of which are misaligned with mainstream brand requirements. Most brands are unwilling to fully decentralize customer data or expose their engagement systems to volatile or unproven public token markets. As a result, the promise of tokenization as a mechanism for loyalty, gifting, and entitlement delivery has remained unrealized—not due to lack of demand, but due to lack of a compliant, brand-safe, user-friendly infrastructure capable of bridging traditional and next-generation consumer engagement systems.

### SUMMARY

The present disclosure described herein directly addresses these structural limitations. It introduces a unified, extensible system that enables the tokenization of disparate digital entitlements, monetization of those assets through brand-to-brand resale, controlled delivery through geo-targeted or context-aware airdrops, and user-side wallet collection, gifting (and regifting), social requesting, and ultimate redemption—all within a rule-based architecture that does not require backend integration or point-of-sale access by the originating system (though untokenization of the digital entitlement back into its original form may involve communication or analogous API contact between the system and the original entitlement issuer's systems). This novel architecture establishes a new economic model wherein digital entitlements evolve from static retention tools into dynamic, transferable, monetizable, and socially intelligent cultural assets.

The present disclosure relates generally to systems and methods for the tokenization, distribution, management, and redemption of digital entitlements. More specifically, it pertains to a unified platform enabling brands, organizations, and digital asset holders to convert disparate value-bearing assets—including loyalty points, promotional codes, digital vouchers, paywall credits, in-game assets, cryptocurrencies, NFTs, fractional investment rights, and other proprietary digital items—into standardized, portable, and socially exchangeable tokens.

This disclosure further relates to the commercialization of such tokenized entitlements through a marketplace model that allows brands (the originating parties) to sell these digital assets to third-party sponsors or promoters, who may then distribute them to end users via a controlled, geo-targeted airdrop mechanism. These tokenized drops may occur in physical locations (e.g., stores, concerts, stadiums, shopping malls, airport terminals) or within symbolic or context-specific digital environments.

The disclosure additionally encompasses systems for consumer interaction with these assets, including wallet-based storage, asset management interfaces, gamified collection mechanics (e.g., loot boxes), and a permissioned social layer that enables peer-to-peer gifting, request-based entitlement visibility, and user-controlled sharing of tokenized assets. All transfers and redemptions are subject to embedded rules (e.g., expiration, redemption limits, metadata control) and are executed within the disclosure's ecosystem without requiring integration with the backend infrastructure of the originating brand or sponsor.

The disclosure establishes a new class of networked digital value exchange infrastructure that simultaneously serves the interests of brands (who monetize or distribute entitlements), consumers (who collect and use these entitlements), and third-party distributors (who leverage tokenized value to incentivize engagement). Importantly, the system supports the conversion of static loyalty programs and siloed rewards systems into dynamic and interoperable cultural currencies aligned with Gen Z values, Web3 principles, and emerging privacy standards (e.g., GDPR, CCPA).

The present disclosure introduces a unified, modular system and method for the creation, monetization, distribution, management, and socially contextualized exchange of digital entitlements. Unlike traditional loyalty programs or digital voucher systems, which are bound to proprietary infrastructures and offer limited user control or interoperability, the present disclosure facilitates the transformation of disparate digital entitlements into transferable, rule-governed, and socially enabled tokenized assets.

At its core, the disclosure enables brands, retailers, publishers, and other digital asset holders (“originating entities”) to tokenize value-bearing entitlements—including but not limited to loyalty points, discount codes, airline miles, in-app currencies, NFTs, crypto credits, paywalled access rights, promotional assets, membership rewards, and crypto coins and crypto currencies (e.g., BTC, ETH, XRP)—without requiring the dismantling or integration of their existing backend infrastructure. These entitlements are abstracted into platform-native, uniquely identifiable tokens governed by embedded rules regarding expiration, redemption limits, permitted use cases, and transferability.

Once tokenized, these assets may be made available for direct sale to third-party sponsors, promotional partners, or affiliated brands. This commercial pathway enables originating entities to convert loyalty liabilities or idle promotional capacity into real-time revenue opportunities—effectively transforming what has historically been a pure cost center into a monetizable class of branded micro-assets.

Third-party buyers, upon purchasing tokenized entitlements from originating entities, may deploy these assets through the system's digital infrastructure using a secure airdrop interface. Airdrops may be configured to target users based on physical geolocation (e.g., proximity to retail outlets, stadiums, airports, or checkout locations), symbolic or event-based coordinates (e.g., music festivals, esports events, virtual gatherings), or digital interaction zones (e.g., engagement with livestream platforms, social content, or QR codes). The system's distribution engine ensures that token dispersal adheres to visibility rules, quantity caps, scheduling constraints, and sponsor-defined access permissions.

Consumers interact with the system via a browser-based or app-based digital wallet. This wallet functions as both a collection interface and personal asset manager. Users may browse nearby or curated airdrops, open virtual loot boxes, and acquire tokenized entitlements. Once collected, users retain full control over which assets to redeem, hold, gift, or selectively reveal. The wallet includes a social visibility layer that allows users to manage access permissions on a per-token or per-connection basis, enabling privacy-conscious signaling, social sharing, or peer-to-peer endorsement.

Critically, users may also gift tokenized entitlements to others, subject to the original asset's embedded transferability rules. The system tracks the transfer path of each token and maintains redemption eligibility across recipients. This functionality enables organic value propagation through social networks and creates new opportunities for multi-hop branded engagement. Users may additionally request tokens from friends, initiate value-for-value exchanges (where permitted by applicable regulations), or broadcast specific asset needs (e.g., “looking for 20% off [Brand]”).

Redemption of tokenized entitlements occurs when the user elects to untokenize the asset, prompting the system to delete the associated token ledger entry (“burn”) and communicate with the originating brand's entitlement system to restore the original entitlement form from an escrowed account held on behalf the managers of the disclosure into the user's personal account with that brand (e.g., points, credits, or codes). Prior to untokenization, the system operates without requiring integration with the originating entity's point-of-sale or backend infrastructure. Only when a user initiates untokenization for fulfillment purposes (e.g., applying flight credit, redeeming streaming access) does the system optionally engage in encrypted communication or API-based handshake protocols with the originating brand's servers to re-establish the asset in native form and credit it to the appropriate user account.

Collectively, these components form a closed-loop digital entitlement infrastructure that:
Enables the tokenization of previously siloed digital entitlements
Establishes a commercial resale mechanism for originating entities to monetize tokenized assets
Facilitates geo-targeted and socially contextual airdrops by third parties
Empowers users with fine-grained wallet management, gifting, and social request mechanics
Creates a new form of user-consent zero-party and first party data generation that is regulatorily permissive, transparent, and ethically robust
Enables brands to “recycle” their marketing budgets whenever there is a mis-targeting of their brand message due to the theoretical potential for never ending regifting by end-users within the platform to one another, ensuring that the brand message is delivered numerous times across numerous social relationships until it likely finds its intended target audience
Supports rule-based redemption and untokenization while preserving privacy, auditability, and brand control

The disclosure thus creates a new, fully-integrated commercial and social framework for digital value transfer. Digital entitlements are no longer static or disposable. Under this disclosure, they become active, portable, monetizable, and socially dynamic units of digital engagement—aligned with contemporary consumer expectations, brand marketing strategies, and regulatory norms.

### BRIEF DESCRIPTION OF THE DRAWINGS

The details of the present disclosure, both as to its structure and operation, may be gleaned in part by study of the appended drawings, in which like reference numerals refer to like parts, and in which:

FIG. 1 is a system-level architectural diagram illustrating the overall Tokenized Digital Entitlement (“TDE”) Creation, Distribution, Social Management, and Redemption System in accordance with one embodiment of the present disclosure;

FIG. 2 is a subsystem diagram detailing the internal structure and operation of the DE Ingestion & Tokenization System in accordance with one embodiment of the present disclosure;

FIG. 3 is a subsystem diagram illustrating the components of the TDE Purchase & Distribution System in accordance with one embodiment of the present disclosure;

FIG. 4 is a subsystem diagram depicting the End-User TDE Locating, Collection, Storing, Managing, Sharing & Redemption System in accordance with one embodiment of the present disclosure;

FIG. 5 is a conceptual diagram outlining the business logic and monetization modules of the system in accordance with one embodiment of the present disclosure;

FIG. 6 is a lifecycle and value flow diagram showing the creation, purchase, distribution, regifting, and redemption of tokenized entitlements in accordance with one embodiment of the present disclosure;

FIG. 7 is a block diagram of music paywall access rewards in accordance with one example implementation of the present disclosure;

FIG. 8A is a block diagram of music paywall access rewards in accordance with another example implementation of the present disclosure;

FIG. 8B is a block diagram of music paywall access rewards in accordance with yet another example implementation of the present disclosure;

FIG. 9A is a block diagram of gaming digital merchandise access rewards in accordance with one example implementation of the present disclosure;

FIG. 9B is a block diagram of gaming digital merchandise access rewards in accordance with another example implementation of the present disclosure; and

FIG. 9C is a block diagram of gaming digital merchandise access rewards in accordance with yet another example implementation of the present disclosure.

### DETAILED DESCRIPTION

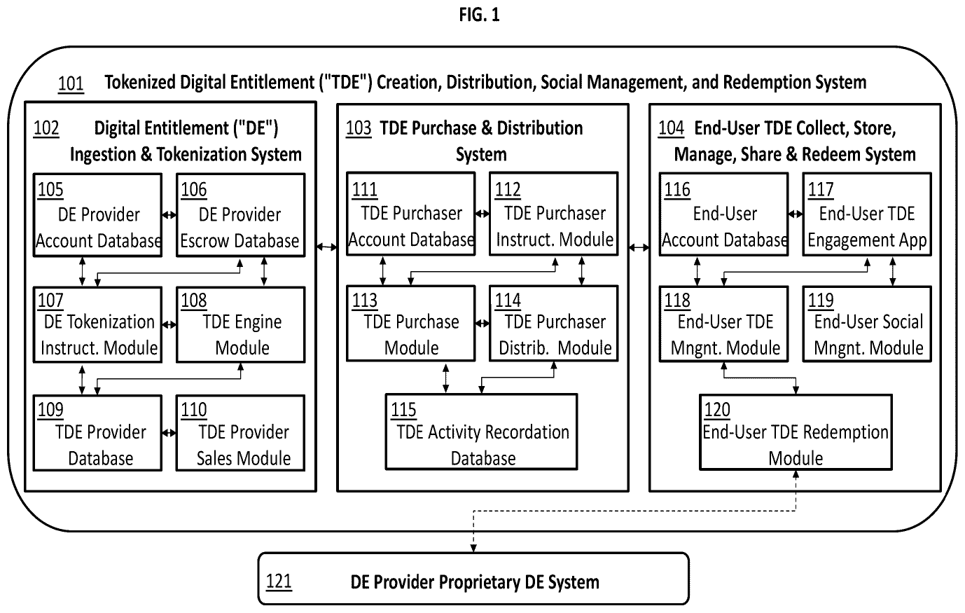

The present disclosure relates to a Tokenized Digital Entitlement (“TDE”) Creation, Distribution, Social Management, and Redemption System, shown generally as system 101 in FIG. 1. System 101 enables the transformation of digital entitlements—such as loyalty points, promotional codes, subscription credits, digital coupons, or other value-bearing assets—into portable, transferable, and tokenized digital units referred to herein as TDEs.

These TDEs are distributed via third-party sponsors through geo-targeted, event-based, or digitally contextual airdrops, and are collected and managed by end-users through a platform-hosted wallet interface. End-users may store, selectively reveal, gift, request, or redeem TDEs under rule-bound conditions embedded at the time of tokenization.

FIG. 1 is a system-level architectural diagram illustrating the overall Tokenized Digital Entitlement (“TDE”) Creation, Distribution, Social Management, and Redemption System (101), and its division into four subsystems including the Digital Entitlement (“DE”) Ingestion & Tokenization System (102), the TDE Purchase & Distribution System (103), the End-User TDE Locating, Collection, Storing, Managing, Sharing & Redemption System (104), and the external DE Provider Proprietary DE System (121), which serves as an optional untokenization endpoint.

System 101 comprises three primary operational subsystems, each encompassing multiple modules as described below (102, 103, 104):

102—Digital Entitlement (“DE”) Ingestion & Tokenization System

This subsystem is responsible for onboarding DE Providers (e.g., merchants or brands), ingesting their native digital entitlements, and converting them into standardized, rule-encoded TDEs. It includes:

105—DE Provider Account Database: Stores registration, login credentials, and authorization metadata for participating DE Providers. This database supports campaign setup, funding, and entitlements submission.

106—DE Provider Escrow Database: Holds pre-funded redemption value or equivalent credit for each tokenization event. For every entitlement converted into a TDE, an appropriate value is reserved or committed to ensure redemption can be honored independently of the provider's backend system.

107—DE Tokenization Instruction Module: Allows DE Providers to define conversion logic, including per-token value, expiration conditions, transferability (e.g., whether a token can be gifted or regifted), and maximum redemption caps. This module structures the entitlement in preparation for encoding.

108—TDE Engine Module: Executes the transformation of the DE into a platform-native TDE. This includes generating a unique token identifier, linking to associated rulesets, registering the token in the ledger, and encrypting or hashing any embedded conditions.

109—TDE Provider Database: Stores all active and historical TDEs originated by each DE Provider. This includes metadata such as campaign name, sponsor eligibility, drop history, and redemption metrics.

110—TDE Provider Sales Module: Enables DE Providers to make their tokenized assets available for third-party purchase. Sales may be public or restricted to approved sponsors and are transacted against predefined quantity limits and budgeted campaign caps.

103—TDE Purchase & Distribution System

This subsystem enables third-party sponsors (TDE Purchasers) to acquire tokenized digital entitlements from DE Providers and distribute them through configured drops. It includes:

111—TDE Purchaser Account Database: Manages sponsor profiles, payment credentials, purchase history, and campaign permissions. This module ensures only authorized third parties may acquire and distribute TDEs.

112—TDE Purchaser Instruction Module: Allows sponsors to select TDEs, configure drop conditions (e.g., location, visibility settings), and define wallet access constraints. This may include event-based triggers, time gating, or maximum claim limits per user.

113—TDE Purchase Module: Manages the financial transaction between the TDE Purchaser and the DE Provider. Once payment is confirmed, token ownership is transferred, and the tokens are made available for drop scheduling.

114—TDE Purchaser Distribution Module: Enables the configuration and execution of the airdrop. TDEs may be dropped based on GPS location, symbolic event markers, QR code activation, or other contextual logic. This module handles release timing, quantity control, and optional loot-box packaging.

115—TDE Activity Recordation Database: Captures all TDE-related activity, including token transfers, redemptions, gifting chains, and drop performance metrics. This immutable ledger ensures transparent attribution, compliance auditability, and behavioral insights for sponsors.

104—End-User TDE Locating, Collection, Storing, Managing, Sharing & Redemption System

This subsystem defines the user-facing experience. It enables discovery, collection, management, and social transmission of tokenized entitlements. It includes:

116—End-User Account Database: Manages end-user identities, wallet credentials, token ownership records, gifting history, and social graph associations (e.g., friends, visibility rules).

117—End-User TDE Engagement App: Provides the primary interface (mobile or browser-based) through which users browse live heatmaps, open loot boxes, and collect nearby or context-specific TDEs.

118—End-User TDE Management Module: Allows users to sort, archive, prioritize, or discard TDEs. Tokens may be organized by brand, expiration date, or redemption type.

119—End-User Social Management Module: Supports selective sharing and visibility controls. Users can configure who may view which tokens, make gifting requests, or transfer entitlements to friends in real-time.

120—End-User TDE Redemption Module: Enables users to initiate redemption of eligible TDEs. The system validates token rules, removes (burns) the token from the wallet, and optionally initiates communication with the DE Provider's native system to reconstitute the original entitlement (see 121).

121—DE Provider Proprietary DE System

This element represents the DE Provider's own backend rewards, points, or value system. It is to be used when contacted by the disclosure at the moment of TDE redemption. The system includes an API bridge (or similar secure handshake protocol) allowing the disclosure platform to untokenize the TDE and post the equivalent value into the end-user's account within the DE Provider's proprietary system. This communication occurs only upon redemption and does not require persistent backend integration. It should be noted that the use of the API is not for posting the equivalent value into the end-user's account within the DE Provider's proprietary system. Rather, it is for a non-intrusive notification via API to the DE point provider, specifying that the DE point provider needs to allocate escrowed points within the system's escrow account(s) to the user's personal account within the point provider's system.

### I. Digital Entitlement (“DE”) Ingestion & Tokenization System

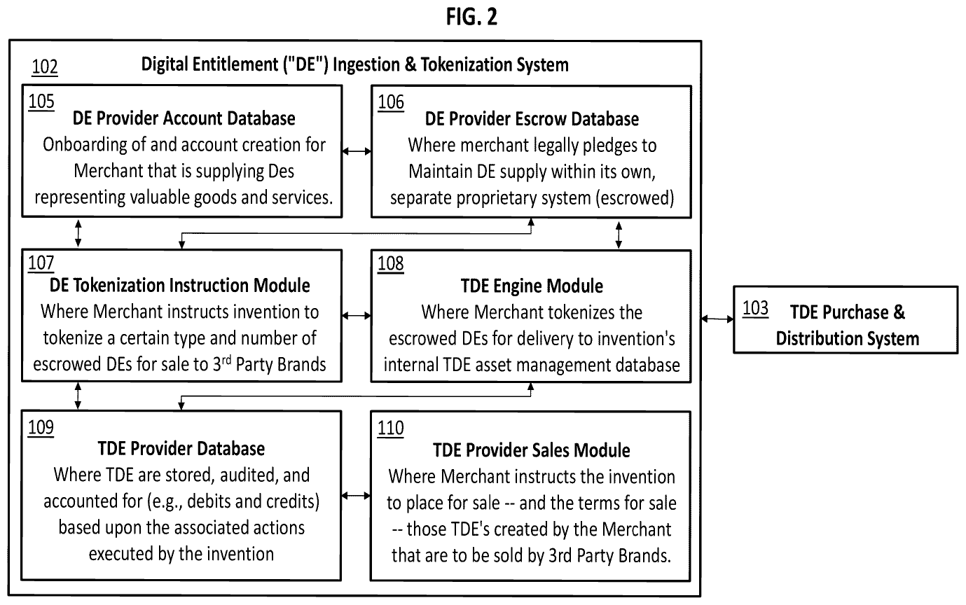

FIG. 2 is a subsystem diagram detailing the internal structure and operation of the DE Ingestion & Tokenization System (102), including the DE Provider Account Database (105), DE Provider Escrow Database (106), DE Tokenization Instruction Module (107), TDE Engine Module (108), TDE Provider Database (109), and TDE Provider Sales Module (110).

The Digital Entitlement (“DE”) Ingestion & Tokenization System (102) is responsible for converting proprietary digital entitlements submitted by originating brands or merchants (“DE Providers”) into standardized, transferable, rule-bound Tokenized Digital Entitlements (“TDEs”). This subsystem forms the intake and creation layer of the disclosure and operates independently from the DE Provider's proprietary infrastructure or reward management systems.

This subsystem comprises six functional elements as illustrated in FIG. 2 and identified as reference numbers 105 through 110, each described below.

### 105—DE Provider Account Database

Element 105 stores registration and account information for each DE Provider authorized to create and tokenize digital entitlements within the system. Each account record may include:
1) Legal entity and brand identity
2) Contact and authorization credentials
3) Associated wallet or escrow account IDs
4) Historical campaign data
5) Tokenization privileges (e.g., approved entitlement types, geographic scope)

Each DE Provider account is linked to entitlements submitted by that provider and is used to enforce campaign-level controls and sales eligibility rules.

### 106—DE Provider Escrow Database

The DE Provider Escrow Database (106) ensures that each tokenized entitlement is supported and backstopped prior to distribution. For every DE submitted to the system, the DE Provider must pre-fund the maximum potential redemption value in kind into an escrow structure, which may take the form of a wallet holding one or more of:
1) Native points (e.g., airline miles, hotel loyalty points)
2) Promotional codes of discounts
3) Fiat-denominated currency
4) A crypto coin, stablecoin, or other non-volatile digital asset, including but not limited to a non-fungible token (“NFT”)

The escrowed value is allocated on a per-token or per-campaign basis and cannot be repurposed once committed. The system validates available escrow before proceeding to token creation to prevent underfunded or “phantom” entitlements from entering circulation.

### 107—DE Tokenization Instruction Module

Module 107 allows the DE Provider to configure how the submitted entitlement is transformed into a TDE. This module acts as a campaign builder or rule compiler and enables the following specifications:
1) Entitlement format (e.g., fixed discount, % off, access token, subscription credit)
2) Redemption rules, including:
3) Minimum spend thresholds
4) Category or product limitations
5) Maximum redemption value per transaction
6) Expiration terms (e.g., fixed date, time window, rolling duration)
7) Transfer rules, such as:
8) Giftable (yes/no)
9) Re-giftable (yes/no)
10) Transfer limit (e.g., max 2 hops)
11) Visibility settings
12) Private token
13) Selectively visible to specific friend groups
14) Publicly shareable via link or request
15) Token batch size and serialization
16) Total tokens to be minted for the campaign
17) Whether tokens are identical or tiered

These instructions are digitally bound to each resulting TDE and govern behavior throughout the token's lifecycle.

### 108—TDE Engine Module

The TDE Engine (108) executes the transformation of entitlements into platform-native, system-recognized Tokenized Digital Entitlements (TDEs). Each TDE:
1) Receives a unique token ID
2) Is digitally registered to the originating DE Provider
3) Is bound to the ruleset compiled in module 107
4) Is associated with a creation timestamp and escrow ledger entry
5) Is stored as an individual token record in the TDE Provider Database (109)

Tokens may be encoded using standardized token schema formats (e.g., JSON or XML), optionally hashed or signed for integrity, and may include redemption hooks to activate outbound APIs at the point of use.

### 109—TDE Provider Database

All generated tokens are stored in module 109—the TDE Provider Database—as active or historical records. Each record contains:
1) Token ID and associated campaign ID
2) Originating DE Provider ID
3) Encoded redemption rules and transfer permissions
4) Escrow reference and redemption ceiling
5) Status (active, distributed, redeemed, expired, revoked)

This database supports:
1) Token lookup and verification
2) Sponsor purchasing logic
3) Campaign audit and performance analysis
4) Integration with analytics dashboards and merchant-facing interfaces

### 110—TDE Provider Sales Module

Once a DE Provider has tokenized their entitlements, the Sales Module (110) enables them to make the resulting TDEs available for purchase by approved third-party sponsors or promotional partners. The DE Provider may define:
1) Token price (flat or dynamic)
2) Campaign availability (e.g., public, private, limited-invite)
3) Preferred or restricted sponsor types (e.g., vertical filters, whitelist IDs)
4) Max tokens per sponsor or per drop
5) Minimum purchase thresholds

The module interacts with the escrow database to ensure token sales do not exceed funded supply and supports reporting of all pending or completed sales.

In some embodiments, the system may allow for rule templates to speed up tokenization, where predefined campaign types can be loaded and slightly modified. In others, tokenization may include visual assets (brand logos, iconography) that appear in the user wallet, though these do not affect entitlement functionality.

Further, while the escrow module (106) is shown as distinct, it may be logically or physically integrated with external payment systems, provided that fund availability is programmatically verifiable before token issuance.

### II. TDE Purchase & Distribution System

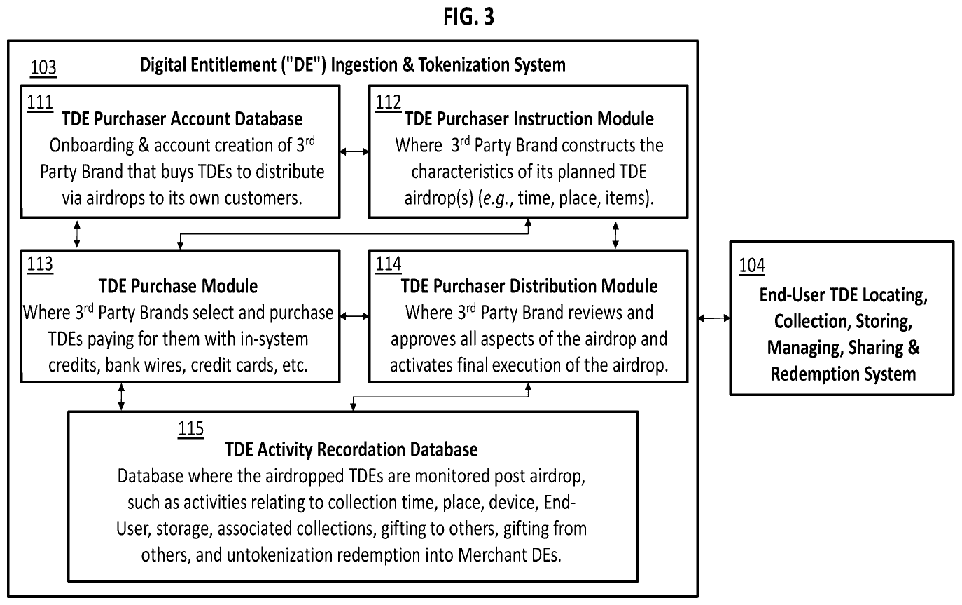

FIG. 3 is a subsystem diagram illustrating the components of the TDE Purchase & Distribution System (103), including the TDE Purchaser Account Database (111), TDE Purchaser Instruction Module (112), TDE Purchase Module (113), TDE Purchaser Distribution Module (114), and the TDE Activity Recordation Database (115).

The TDE Purchase & Distribution System (103) enables third-party brands, sponsors, promoters, or affiliates (“TDE Purchasers”) to acquire tokenized digital entitlements (TDEs) from originating Digital Entitlement (DE) Providers and configure them for public or private distribution to end users. This subsystem includes modules for account creation, purchase workflow, campaign configuration, airdrop scheduling, and event logging. All components are logically connected to the broader Tokenized Digital Entitlement system (101) and reference modules 111 through 115.

### 111—TDE Purchaser Account Database

Element 111 manages account profiles for all third-party purchasers that intend to acquire and distribute TDEs. Each TDE Purchaser record includes:
1) Legal entity or brand sponsor name
2) Contact credentials and authorized representatives
3) Wallet and payment authorization (e.g., pre-funded credit or linked financial instruments)
4) Purchase history and campaign metadata
5) Access permissions (e.g., industry-specific restrictions, DE Provider allowlisting)

Account profiles are used to enforce eligibility filters, validate payment readiness, and maintain attribution across campaigns.

### 112—TDE Purchaser Instruction Module

This component enables the TDE Purchaser to define and configure key campaign parameters prior to initiating any token acquisition. This includes:
1) TDE selection: filtering token availability by DE Provider, brand category, entitlement type, value tier, or campaign status
2) Redemption audience targeting: such as age group, event type, geo-fence region, or device-based access
3) Scheduling options:
   Start and end times
   Single-day drop windows
   Recurring campaign logic
   Delivery rules: including loot box packaging (randomization tiers), delivery throttling, proximity gating, or public/private access toggles
   Budget and quantity controls: specifying max tokens to acquire, max tokens to distribute per hour/day, or cap per user

The instruction module interfaces directly with the DE Provider's campaign configuration via the TDE Provider Sales Module (110), ensuring that purchases match provider-side constraints (e.g., minimum buy amounts, eligible sponsor filters).

### 113—TDE Purchase Module

The TDE Purchase Module (113) executes the financial transaction and token allocation process. It performs the following steps:
1) Validates the TDE Purchaser account (111) and campaign instructions (112)
2) Interfaces with the DE Provider's escrow ledger to ensure sufficient supply
3) Transfers tokens from the TDE Provider Database (109) to a holding pool assigned to the TDE Purchaser
4) Deducts campaign cost from purchaser's wallet or linked payment source
5) Generates a purchase record linking the token IDs to the purchaser ID, campaign ID, and payment reference

Upon successful transaction, tokens are marked for distribution and become available to the Drop Configuration and Execution module (114).

### 114—TDE Purchaser Distribution Module

This module enables the execution of the token drop to the intended public or private user base. Supported drop formats include:
1) Geolocation drops: requiring users to physically be within a radius (e.g., 100 meters) of a known coordinate
2) Event-based drops: e.g., tied to a concert, stadium event, or product launch
3) Contextual drops: activated by QR scans, livestream interactions, or branded campaign links
4) Scheduled visibility drops: where loot boxes are placed on the map but only visible during certain hours or dates
5) Limited edition or first-come-first-served drops: configured with quantity caps and claim race conditions

Each campaign is assigned a Drop ID, and each token drop is tracked to the specific instructions, timing, location, and sponsor identity. The distribution module supports:
1) “Open box” mode (tokens visible individually)
2) “Loot box” mode (bundled with probabilistic tiering logic)
3) “Invite only” mode (requiring social unlock, referral, or verified fan access)

The system can throttle token visibility based on device type, user volume, or high-demand event windows to prevent abuse or resource overload.

### 115—TDE Activity Recordation Database

All sponsor-side and token drop events are recorded in module 115, including:
1) Token purchases
2) Drop configuration metadata
3) Distribution timing and location
4) End-user pickups (initial collection event)
5) Gifting and regifting events (if allowed)
6) Redemption outcomes
7) Abandonment or expiration of unused tokens

Each record includes token ID, timestamps, sponsor ID, campaign ID, and user ID (if available). The ledger may optionally support hashed, encrypted, or privacy-respecting fields depending on regional data compliance requirements (e.g., CCPA, GDPR).

This database is used for:
1) Attribution analytics
2) Conversion tracking
3) Compliance reporting
4) Dispute resolution
5) Redemption verification

The recordation module may also support third-party API access (read-only or filtered) to enable DE Providers or sponsors to generate live dashboards or external attribution reports.

In alternative configurations, TDE Purchasers may receive volume discounts or automatic token assignment algorithms, where the system auto-pairs sponsors with unsold tokens from providers in their allowed categories.

Further, the system may enable “open sponsor” settings, where a DE Provider allows any approved purchaser to configure and drop tokens from their available pool in a decentralized manner, subject to automatic escrow adjustment.

### III. End-User TDE Locating, Collection, Storing, Managing, Sharing & Redemption System

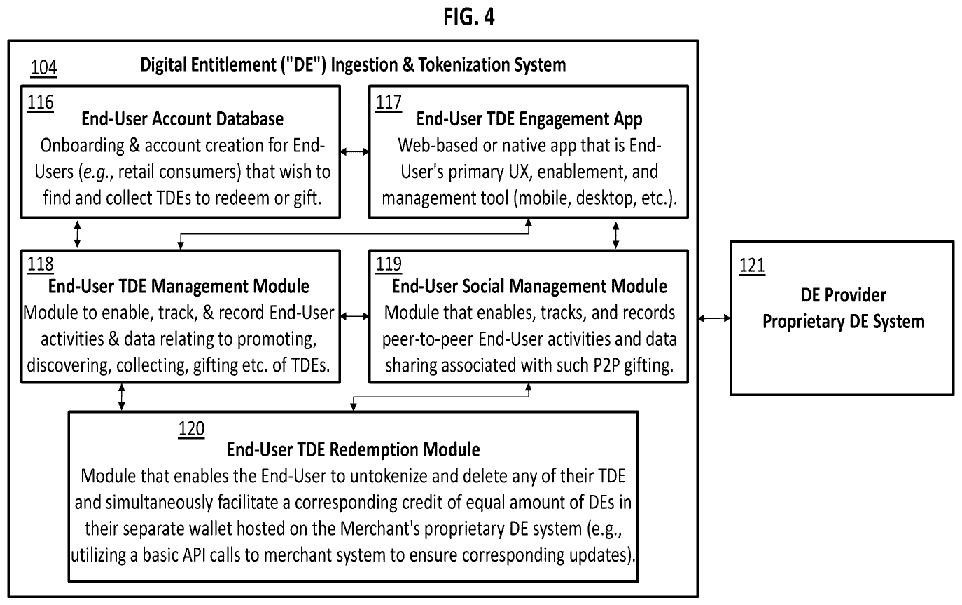

FIG. 4 is a subsystem diagram depicting the End-User TDE Locating, Collection, Storing, Managing, Sharing & Redemption System (104), including the End-User Account Database (116), End-User TDE Engagement App (117), End-User TDE Management Module (118), End-User Social Management Module (119), and End-User TDE Redemption Module (120).

The End-User TDE Locating, Collection, Storing, Managing, Sharing & Redemption System (104) enables consumers (“end users”) to discover, claim, store, manage, gift, and ultimately redeem Tokenized Digital Entitlements (TDEs). This system element provides the full user-side interface and interaction layer of the disclosure and is distinct from any merchant backend, sponsor control panel, or DE Provider infrastructure.

System 104 is composed of five primary elements (116-120), which together form a browser-based or app-based interface for engagement and entitlement lifecycle management.

### 116—End-User Account Database

Element 116 stores persistent user profiles, digital wallet credentials, social connection data, and collected token records. Each user account record may include:
1) Unique user ID (pseudonymous or linked to verified credentials)
2) Login and device authentication data
3) A secure list of currently held TDEs and their metadata
4) Gifting and request history (inbound and outbound)
5) Friend graph or social visibility preferences
6) Redemption history and status flags

This database enables secure, permissioned access to the user's wallet and supports session persistence across multiple devices or browsers.

### 117—End-User TDE Engagement App

This app element provides the primary user interface through which individuals interact with the system. The engagement app may be rendered as:
1) A mobile-responsive browser-based interface
2) A native iOS or Android application
3) A lightweight webview embedded into partner brand ecosystems

Within this interface, users may:
1) View a real-time heatmap or event feed of active TDE drops
2) Navigate to nearby or contextually relevant loot boxes
3) Tap to open loot boxes and reveal one or more tokenized entitlements
4) Filter available drops by brand, category, or required action
5) Access the contents of their wallet and organize their holdings

Each loot box may be visually branded or color-coded to reflect rarity, value tier, sponsor identity, or redemption urgency.

### 118—End-User TDE Management Module

Element 118 provides wallet-level functionality, enabling users to manage their collection of TDEs. Features may include:
1) Sorting by expiration, value, brand, or category
2) Archiving expired or redeemed tokens
3) “Favoriting” or flagging TDEs for upcoming use
4) Notification settings for redemption windows or nearby compatible vendors

Each token listing includes:
1) Token ID
2) Ruleset preview (e.g., “$5 off any order over $20”)
3) Redemption status
4) Transferability and gifting eligibility
5) Originating brand and campaign ID

The management module enables users to maintain an orderly collection of entitlements and evaluate usage options at a glance.

### 119—End-User Social Management Module

This element governs user-to-user visibility, gifting, and request functionality. Users may:
1) Define trusted contacts (e.g., friends, family, colleagues)
2) Choose which tokens are visible to whom
3) Enable “open gift” mode, allowing others to request available TDEs
4) Directly send a token to a friend as a gift, subject to transfer rules
5) Accept or decline gift requests

For privacy, social visibility settings may include:
1) “Only me”
2) “All friends”
3) “Friends of friends”
4) “Visible to requesters only”
5) “Public (discoverable)”

This module enables TDEs to become socially active objects—fostering endorsement, organic sharing, and real-world gifting that increases utility and reach for both sponsors and users.

### 120—End-User TDE Redemption Module

The redemption module is where TDEs are formally exchanged for real-world or digital value. This process occurs within the platform and may optionally trigger an untokenization process (see 121). Steps include:
1) Eligibility Check: The system verifies redemption rules:
   Is the token still valid?
   Has it already been redeemed or transferred?
   Are all conditions met (e.g., minimum spend, product category)?
2) Burn & Record: Upon successful validation, the token is removed from the user's wallet (i.e., “burned”) and logged in the TDE Activity Recordation Database (115).
3) Redemption Action:
   For cash-back or coupon-style entitlements, the user may receive a credit, direct payout, or digital confirmation (e.g., QR code or redeemable promo code).
   For integrated brand systems, the platform may send an API request to the DE Provider's system (via element 121), resulting in a loyalty point or subscription being credited to the user's external account.

The module also supports:
1) Redemption confirmations via email, push, or in-app message
2) Redemption fail reasons and instructions (e.g., “token expired,” “minimum spend not reached”)

In some embodiments, gifting events may trigger automatic notification cascades to incentivize further peer engagement. In others, redemption may be configured to occur automatically when a receipt is uploaded and validated (e.g., post-purchase cashback reward model).

Redemptions may also support tiered delivery, where higher-value TDEs require additional verification, ID matching, or location confirmation prior to fulfillment.

### IV. DE Provider Proprietary DE System

### (Element 121, Referencing FIG. 1 and Applicable to FIGS. 2-4)

The DE Provider Proprietary DE System (121) represents the external and independent platform on which the original digital entitlement (DE) was created, issued, and managed by the DE Provider (e.g., a loyalty platform, e-commerce backend, travel rewards program, or content subscription system). This system is typically owned and operated by the brand, merchant, or partner who originally issued the DE and serves as the endpoint for final fulfillment following successful token redemption within the disclosure's platform.

The system is architecturally external and unconnected by default but may be optionally accessed via temporary API integration or handshake mechanisms under narrowly defined redemption conditions.

### Purpose of Element 121

Element 121 exists to support the off-ramping of a redeemed Tokenized Digital Entitlement (TDE) back into the DE Provider's native account system—thereby reconstituting the original entitlement in a form the DE Provider's proprietary software can process. This may include:
1) Crediting airline miles to a frequent flyer account
2) Applying a digital subscription to a user's streaming profile
3) Adding loyalty points to a retail rewards wallet
4) Enabling digital content access (e.g., premium game unlocks, eBooks, courses)
5) Applying a digital discount or store credit to the user's next online purchase

This untokenization process occurs only at the request of the user, after redemption has been initiated and validated by the platform.

### Offramp Operation: Redemption and Untokenization Sequence

1) Redemption Trigger: The user initiates redemption from their wallet (via element 120), and the token is validated, burned, and logged within the system (via element 115).
2) Redirection or API Call: Based on metadata embedded in the token at the time of issuance (via element 107), the system may:
   Redirect the user to a claim portal (e.g., via SSO token, voucher code, or auto-filled form)
   Send an authenticated API call or encrypted handshake to the DE Provider's fulfillment endpoint, including:
   Token ID or redemption code
   User identifier (anonymous or mapped to verified identity)
   Timestamp and redemption details
3) Value Reinstatement: The DE Provider system (121) receives the redemption request and applies the corresponding entitlement (e.g., value, credit, access) to the user's external account.
4) Confirmation: The DE Provider may return a success or failure message to the platform, which is then surfaced to the end-user via the engagement app (117).

### Optional Authentication and Identity Handling

In some embodiments, redemption may require matching the user to a pre-existing DE Provider account. The system may support:
1) SSO integration or OAuth workflows
2) Unique voucher codes tied to DE Provider logic
3) Email verification or user ID matching
4) Real-time creation of new accounts on the DE Provider's system for frictionless fulfillment

In all cases, system 101 does not require persistent integration with the DE Provider's infrastructure. It remains agnostic to the provider's internal architecture and engages only when a redemption action requires the DE to be reconstituted externally.

### Data Privacy and Control

The redemption event and API exchange may be designed to preserve user privacy, such that:
1) The platform does not share user-identifiable information unless explicitly authorized
2) Token IDs or campaign references are used as proxies to trigger fulfillment
3) End users maintain control over when and how their data is shared with third parties

In less integrated use cases, the DE Provider may preload a set of single-use redemption codes into the system at the time of token creation. These codes are matched one-to-one with distributed TDEs and surfaced to the user only upon redemption, with no outbound API required. This enables fulfillment without any real-time connection between the system and the DE Provider.

### V. Business Logic and Platform Monetization Architecture

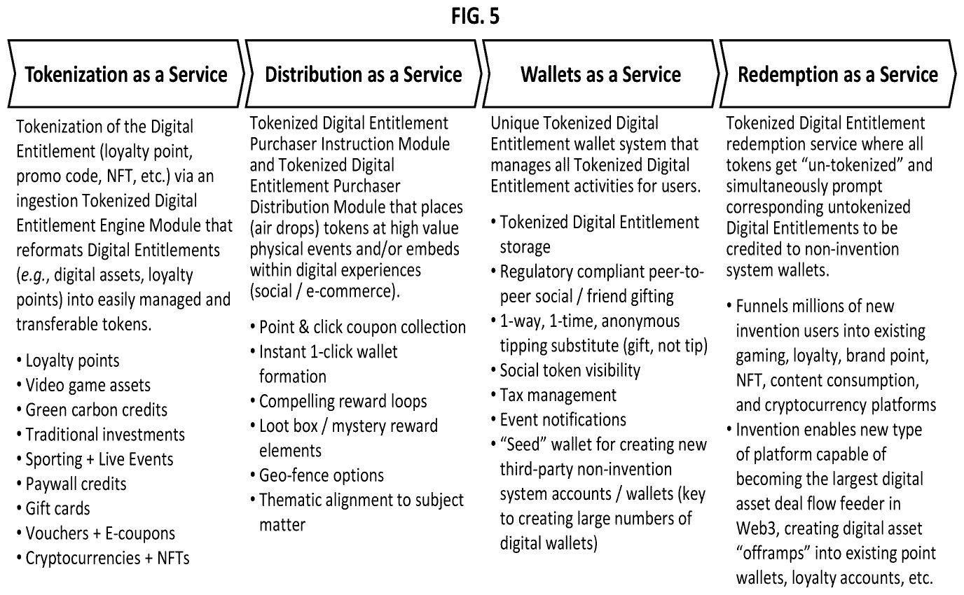

FIG. 5 is a conceptual diagram outlining the business logic and monetization modules of the system, including Tokenization-as-a-Service, Distribution-as-a-Service, Wallet-as-a-Service, Redemption-as-a-Service, and Social Engagement and Gifting Mechanics. These layers illustrate the disclosure's multi-party monetization strategy and flexible deployment as a service platform. FIG. 5 also illustrates the modular business architecture of the present disclosure, showing how each core functionality layer of system 101 can operate as a discrete monetizable service. These business modules enable a flexible, scalable SaaS deployment model, with support for usage-based billing, value-based tiering, and marketplace-driven revenue sharing. The key functional modules include:
1) Tokenization-as-a-Service: Brands and merchants use the platform to tokenize digital entitlements into transferable assets without altering or exposing their internal systems. This includes configuration, escrow, and rule-based issuance.
2) Distribution-as-a-Service: Third-party brands and sponsors purchase TDEs and configure targeted drop campaigns. Revenue may be collected per drop, per location, or via campaign-level bidding in high-value zones (e.g., Super Bowl, Comic-Con).
3) Wallet-as-a-Service: End users manage their collected TDEs through the platform's digital wallet. Brands may pay to customize wallet interfaces, maintain persistent brand visibility, or link wallet activity to off-platform conversion events.
4) Redemption-as-a-Service: The platform optionally manages final value transfer, from cashback issuance to subscription unlock. In cases where brands provide fulfillment, the platform acts as a token redemption processor with optional API handshakes.
5) Gifting & Social Endorsement Loop: The platform monetizes interpersonal value transfer by enabling gifting features, social visibility, friend requests, and targeted outreach—all anchored in active TDEs.

This architecture ensures the present disclosure is not only technically robust, but commercially extensible, with monetization opportunities aligned to each phase of token movement—from creation and drop to gifting and redemption.

### VI. Lifecycle and Value Propagation Flow

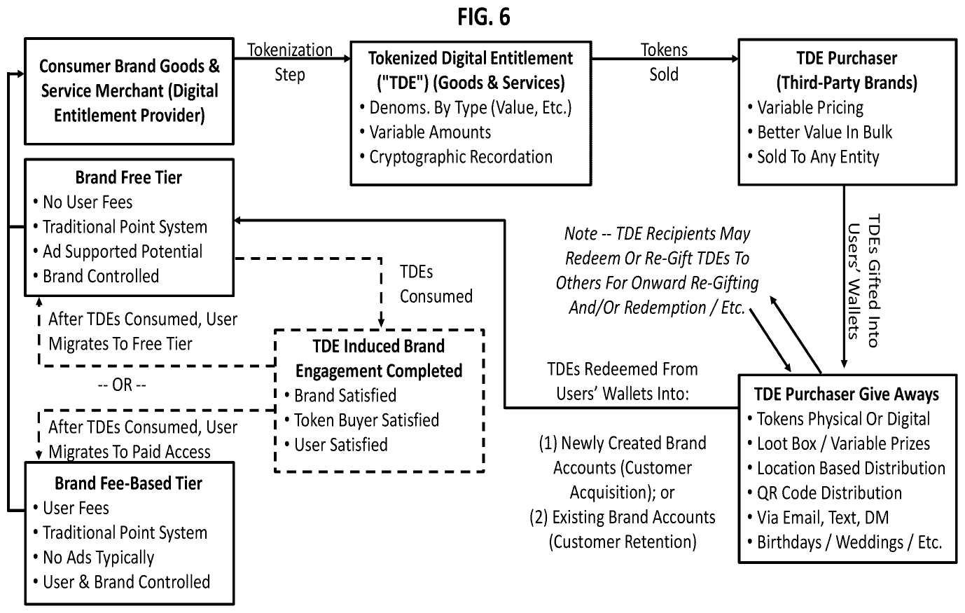

FIG. 6 is a lifecycle and value flow diagram showing the creation, purchase, distribution, regifting, and redemption of tokenized entitlements. This diagram also visualizes the amplification of brand messaging through peer-to-peer gifting, as well as the offramp pathway through which redeemed tokens may be untokenized and reinstated within the originating DE Provider's proprietary system (121). FIG. 6 also illustrates the full lifecycle of a Tokenized Digital Entitlement from creation to final redemption, while highlighting key value amplification features inherent in the system:
1) DE Tokenization: A merchant (DE Provider) converts value into a TDE, pre-funds redemption, and defines usage rules.
2) Sponsorship Purchase: A third-party brand purchases and drops the TDEs to users via high-visibility or geo-targeted campaigns.
3) End-User Collection: The initial user collects the token via loot box or heatmap interaction.
4) Regifting Loop: If the user does not personally value the token, they may gift it to a friend—either proactively or in response to a request—and this loop may repeat multiple times.

Regifting as Advertising Spend Amplification: Each hop in the regifting loop constitutes a consensual peer-to-peer endorsement—a powerful amplification of the original brand message without additional media cost. The TDE is not wasted or abandoned; rather, it “bounces” socially through a network of users until it reaches an individual who values it enough to hoard it (i.e., refuses to regift and eventually redeems it). This is the world's first instance where an advertiser can “recycle” their ad spend dollars when an initial message targeting activity fails to hit its intended mark. In theory, the tokens will not likely be deleted/burned by the holder since they are deemed to hold intrinsic value (if not much by the holder given their personal preferences), and as such will continue to be forwarded to what the gifted suspects is a party that will recognize the inherent value and engage accordingly by hoarding the receive tokens as opposed to onward regifting the tokens.

This “value hoarding” behavior signals true product-market fit and optimizes advertising ROI by allowing user networks to self-target the most appropriate recipient—all with verifiable attribution and no privacy violation.

### VII. Alternative Embodiments

While some embodiments use browser-based access and centralized database architecture, other versions of the system may include:
1) Blockchain-based Token Registry: In some versions, token creation and transfer records may be logged to a public or permissioned blockchain, enabling full decentralization of ownership history and trustless redemption proofs.
2) Offline Drop Activation: Rather than relying on heatmaps or digital proximity, TDE drops may be activated through printed QR codes, NFC devices, or promotional merchandise which links to specific token campaigns.
3) Brand-Cooperative Drop Models: Multiple DE Providers may pool TDEs into cooperative “sponsor boxes,” allowing users to unlock bundles of entitlements from diverse sources in a single drop experience.
4) Instant-Claim Mode: In certain versions, users may instantly receive TDEs without loot boxes or map browsing, particularly for digital-only drops or reward-based calls-to-action (e.g., watching a video, completing a survey).

### VIII. Consent-Based Zero- and First-Party Data Strategy (GDPR/CCPA-Aligned)

Unlike traditional adtech ecosystems built on cookies, cross-site surveillance, or opaque profiling, the present disclosure is built from the ground up to support consent-based, privacy-compliant data collection, yielding the most valuable category of brand data:
1) Zero-party data: Direct user-declared preferences (e.g., which brands they collect or gift from)
2) First-party data: Observed wallet behaviors and gifting patterns within a closed ecosystem

Each gifting event, regifting chain, redemption, or request creates a verified signal of brand interest, product desirability, and social influence. Users voluntarily share visibility into their wallets, define gifting rules, and expose selective value preferences—all under conditions that comply with GDPR, CCPA, and similar frameworks.

In aggregate, this enables DE Providers and TDE Purchasers to:
1) Understand which users hoard or gift their tokens (a signal of personal vs. social brand affinity)
2) Discover high-value users through social graph analysis (based on gifting chains and redemption density)
3) Offer opt-in personalization, reward systems, or influencer partnerships based on real, observed behavior—not inferred segments

This approach creates a privacy-first engagement architecture in which users retain control, brands gain actionable insight, and regulators see alignment with next-generation data collection ethics.

### Alternative Embodiment—System and Method for Providing Digital Rewards to Delayed Travelers at Transportation Hubs

Abstract—A system and method for providing location-based, time-sensitive digital rewards to travelers experiencing delays at transportation hubs. The system identifies the delay, targets the travelers through a mobile application, and offers digital rewards sponsored by brands, enhancing the delay experience and allowing for precise marketing engagements.

Overview—The proposed invention introduces a unique method and system designed to enhance the experience of travelers encountering delays at various transportation hubs, including airports, train stations, and bus stations. This system leverages real-time data integration and mobile technology to offer targeted digital rewards to these travelers, thereby turning a potentially negative travel experience into a more positive one. This approach not only benefits the travelers but also provides an excellent opportunity for brands to engage with a captive audience in a meaningful way.

Problem Addressed: Travel delays are a common, often inevitable aspect of modern transportation, affecting millions of travelers daily. These delays can lead to frustration and dissatisfaction, impacting traveler morale and perception of the involved service providers including airlines and transit authorities. Current solutions to mitigate the impact of such delays are often passive, such as offering access to lounges or providing standard compensation, which may not adequately address the immediate need for a positive engagement or distraction.

Innovation and Its Implementation: This invention stands out by proactively utilizing the idle time of delayed travelers to offer them digital rewards. These rewards are provided through a mobile application that travelers install on their smartphones. The application is designed to perform several functions:
1) Real-Time Location Tracking: To determine the traveler's presence within a specified zone of a transportation hub where delays are occurring.
2) Delay Detection: Integration with APIs that provide real-time updates on flight, train, or bus schedules to detect any delays as they happen.
3) Activation of Digital Rewards: When a delay is detected, the system triggers a notification to the mobile devices of affected travelers, offering them digital rewards such as discount vouchers, free digital content, or exclusive offers, sponsored by third-party brands.
4) Redemption Process: The application facilitates easy redemption of these rewards within the app, enhancing the user experience and providing instant gratification.

Technical Advantages: The technical framework of this invention includes a robust backend capable of handling large datasets and real-time analytics to accurately identify delay scenarios and target the affected traveler demographic. It uses advanced algorithms for geofencing, ensuring precise targeting within the confined geographic locales of transportation hubs. This system's responsiveness and accuracy in deploying rewards not only increase brand engagement rates but also improve the likelihood of creating positive associations with the brands involved.

Commercial Potential: From a commercial perspective, this invention opens up new avenues for targeted advertising and customer engagement within the travel industry. By directly addressing travelers during delays—moments when they are most likely receptive to distraction—the system facilitates deepened customer-brand interactions. Brands get a unique opportunity to present themselves as alleviators of inconvenience, potentially leading to enhanced customer loyalty and brand affinity.

User Experience and Interaction: The user interface of the application is designed to be intuitive and engaging, ensuring that travelers can easily navigate through offers and rewards. The system also includes features for personalization, learning user preferences over time to provide more tailored rewards in future interactions. This personalization not only enhances the user experience but also increases the effectiveness of marketing campaigns deployed through the system.

Implementation Challenges and Solutions: The deployment of this system involves navigating various challenges, including the integration with diverse transportation databases and maintaining high standards of privacy and data security. The system architecture is designed with a focus on scalable, secure frameworks that protect user data while providing reliable and timely service.

Conclusion: This invention provides a timely solution to a widespread issue in the travel industry, using technology to transform travel delays into opportunities for both travelers and brands. It offers practical application of digital marketing techniques, real-time data analytics, and mobile technology to create a novel ecosystem that benefits all stakeholders in the travel process.

Field—The present invention pertains to the field of digital marketing, specifically leveraging mobile technology and real-time data analytics for enhancing user experience during unforeseen delays at transportation hubs. It integrates concepts from geolocation technologies, real-time communication, and personalized content delivery to engage users in a context-aware manner.

This invention focuses on the application of these technologies within airports, train stations, and bus stations, where travelers often experience delays. The ability to dynamically interact with these travelers through digital content directly on their mobile devices during these waiting periods represents a novel approach to location-based marketing and customer service.

The field of this invention intersects with several areas of technology and consumer engagement:
1) Mobile Application Development: Developing software applications that run on mobile devices and utilize native hardware features such as GPS for geolocation tracking and push notifications for real-time engagement.
2) Data Analytics: Analyzing large volumes of real-time data to detect patterns, such as the occurrence of a delay, and to tailor marketing strategies accordingly.
3) Digital Marketing: Crafting and executing marketing campaigns that deliver targeted advertising based on the user's current location and situation (e.g., experiencing a delay).
4) User Experience Design: Designing interactions that are contextually relevant and enhance the user's experience during potentially negative situations, turning them into opportunities for positive brand engagement.

Through these integrated technological and marketing approaches, the invention aims to improve the experience of travelers at transportation hubs by providing them with timely, relevant, and engaging digital rewards. These rewards not only serve to alleviate the discomfort of waiting but also offer strategic branding opportunities for businesses that sponsor these rewards. This inventive approach promises to transform idle waiting time into an engaging, interactive, and rewarding experience, thereby leveraging what is typically a logistical challenge into a marketing opportunity.

### Background

Importance of Traveler Experience: Travel, whether for business, leisure, or commuting, is a significant part of modern society. With the increasing globalization of business and expansion of personal travel, airports, train stations, and bus terminals have become critical nodes in the global transportation network. As the volume of travelers continues to rise, so too does the complexity of managing these hubs efficiently. Delays—caused by factors such as weather, technical issues, or logistical challenges—are inevitable and can significantly impact traveler satisfaction and overall experience.

To get a sense of how often travelers can experience delays (and how persistent and universal this problem is and likely will continue to be) due to a wide range of factors that impact transportation systems. Here are some common scenarios where travelers might face delays:
1) Weather Conditions: Inclement weather is one of the most common causes of delays in travel. This includes severe storms, hurricanes, snow, fog, or even volcanic ash clouds. Such weather conditions can affect flight takeoffs and landings, as well as the operation of trains and buses.
2) Technical Issues: Mechanical problems with a vehicle, such as engine troubles or malfunctioning navigation systems, can cause significant delays. This applies to airplanes, trains, and buses alike.
3) Air Traffic Congestion: At busy airports, the volume of air traffic can lead to delays. Planes might spend longer time taxiing on the runway or waiting for a slot to take off
4) Security and Safety Inspections: Increased security measures or unexpected safety checks can slow down boarding processes and lead to delays across all modes of transportation, especially in heightened alert conditions.
5) Crew Scheduling Issues: Airlines, as well as rail and bus operators, face operational challenges if there are not enough crew members available due to scheduling errors or last-minute illnesses.
6) Strikes and Labor Disputes: Industrial action by airline, train station, or airport staff can disrupt travel schedules and cause delays.
7) Regulatory Delays: Sometimes, regulatory approvals for flights, especially international ones, can be delayed, affecting the flight's scheduled departure.
8) Infrastructure Issues: Problems with airport, railway, or bus station infrastructure, such as a malfunctioning runway light or signal failures on train tracks, can lead to delays.
9) High Passenger Volumes: During peak travel seasons or specific events, high passenger volumes can overwhelm the capacity of airports, stations, or the vehicles themselves, leading to slower check-ins, security checks, and boarding, thus delaying departures.
10) Medical Emergencies: If a passenger or crew member falls ill, it may cause delays while medical assistance is sought, which could include diverting an aircraft or stopping a train.
11) Accidents and Collisions: On the roads and railways, accidents or collisions can halt or delay traffic, affecting bus and train schedules.
12) Unscheduled Maintenance: Sometimes, unscheduled maintenance is necessary to fix safety issues that, if left unattended, could lead to more severe problems or accidents.

Moreover, the delays caused by the scenarios mentioned above can happen in various locations, not just in airport lounges and gates. Here are some common areas where travelers might experience delays:
1) Airport Lounges and Gates: Delays at the boarding gate or in lounges are common due to boarding issues, late-arriving aircraft, or crew changes.
2) Runways and Taxiways: Aircraft can be delayed on the runway or taxiway due to traffic congestion, bad weather, or technical checks.
3) Check-in and Security Checkpoints: Long queues at check-in counters or security checkpoints can delay travelers even before they reach the boarding area.
4) Baggage Claim Areas: Delays in baggage handling can also keep passengers waiting longer after their flight has landed.
5) Train Platforms: Delays can occur at train stations on the platforms due to signal failures, track issues, or late-arriving trains.
6) Bus Stations: Bus departures can be delayed at bus stations or terminals due to traffic conditions, technical problems with the bus, or scheduling issues.
7) On the Road or Track: For trains and buses, delays can occur while en route, not just at the station. This can be due to track obstructions, road traffic, or accidents.
8) Boarding Areas: In airports, seaports, and bus terminals, the boarding areas can also experience delays if there are issues with boarding operations or passenger documentation.
9) Customs and Immigration: International travelers can face delays in customs and immigration areas due to paperwork issues, staffing shortages, or technology failures.
10) Air Traffic Control Centers: Delays can also originate from decisions made at air traffic control centers, affecting planes still in the air and not just those on the ground.

Current Approaches to Managing Delays: Current strategies to manage the inconvenience caused by delays typically involve direct compensation, such as meal vouchers, accommodation, or refunds from the party offering the service directly linked to the delay. While these are often appreciated, they may not fully mitigate the frustration experienced by travelers. Moreover, these approaches are reactive rather than proactive and often do not engage the traveler in a manner that positively affects their perception of the waiting time.

Emotional Power of Relationship Affirming Gifts from Brands to Emotionally Low Customers: As such, there is a need for a more novel approach of engagement at this time. Either the service provider directly associated with the delay can offer a digital gift or reward to the passenger for storage in their digital wallet and use thereafter that is an air mile or something else (a token, coupon, or gift card for discounted clothing, food, etc.) or another party or brand not directly responsible for or associated with the delay may do the same type of digital asset give-away to the delayed passengers who are easily identified “captured consumers” and may be approached in an emotionally advantageous state (i.e., the best consumer relationships between consumers and brands often happen when the consumer is at an emotional low point and the brand provides a gift or other pleasantry to lift their spirits and show appreciation for their patronage).

Digital Engagement and Marketing: The rise of digital technology has transformed marketing strategies across all sectors. In transportation, digital displays and mobile app notifications offer real-time information and promotional content. However, these technologies are not always used to their fullest potential to enhance user experience during delays. Most current applications focus on providing information rather than leveraging the situation to offer targeted, engaging content that can improve the traveler's mood and experience.

Opportunities for Improvement: There is a significant opportunity to improve how travelers are engaged during delays. By integrating real-time delay data with digital marketing techniques, it is possible to offer more than just compensation; one can provide a positive, engaging experience that can alter travelers' perceptions of the inconvenience they are enduring. This approach can lead to higher levels of traveler satisfaction and loyalty, which are crucial metrics for transportation hubs and associated businesses.

Technological Integration in Transportation: Advancements in technology such as geolocation, real-time data processing, and mobile communication have opened new avenues for engaging with travelers. These technologies can be harnessed to detect when and where travelers are experiencing delays and to deliver timely, contextually relevant content directly to their mobile devices.

Prior Art and Limitations: Existing solutions often lack the integration of real-time delay data with proactive digital marketing strategies. While there are numerous apps and systems that track delays, few utilize this information to provide immediate, personalized marketing content. Furthermore, existing marketing strategies at transportation hubs are generally static and not personalized, missing the opportunity to engage with travelers based on their immediate context and emotional state.

Need for a Novel Solution: The limitations of current technologies and strategies highlight the need for a novel solution that not only addresses the gap in digital engagement during travel delays but also enhances the overall experience by turning waiting time into an opportunity for both travelers and brands. Such a solution would leverage the latest in digital and mobile technologies to provide timely, enjoyable, and valuable content to delayed travelers, thereby transforming the travel delay experience into a positive interaction.

### Detailed Description

Overview of the System: The invention comprises a mobile application integrated with a backend system that collaborates to provide digital rewards to travelers experiencing delays at transportation hubs. This system utilizes real-time data from transportation schedules, user location data, and brand-sponsored reward databases to engage users during travel disruptions.

System Architecture: The system architecture includes the following key components:
1) Mobile Application: Installed on the user's mobile device, it accesses GPS and network data to ascertain the user's location and communicate with the backend server.
2) Backend Server: Processes real-time transportation data, user locations, and manages the distribution of digital rewards. It also handles data analytics for optimizing reward targeting and campaign performance.
3) Data Sources: Real-time feeds from transportation entities (airports, train stations, etc.) providing updates on delays, and databases containing information about available rewards from participating brands.

### Functional Description:

1) Real-Time Delay Detection: The system continuously receives and analyzes schedule data from transportation hubs. Using machine learning algorithms, it predicts and detects delays in real-time (see expanded description on these important features below).
2) User Location Verification: When a delay is detected, the system identifies users who are within the affected area using geolocation data from their mobile devices.
3) Reward Triggering and Notification: Once a user is identified as being in a delayed situation, the system triggers a notification to their mobile device offering a digital reward.
4) Reward Redemption: The user can accept the reward through the app, which provides digital or scannable code that can be used at participating vendors, either within the transportation hub or online.

Real-Time Data Scraping for Targeting Digital Asset Rewards: The present invention incorporates a sophisticated approach to collecting and utilizing real-time data from publicly available sources to identify optimal opportunities for deploying digital asset rewards to delayed travelers. This process involves scraping data related to transportation schedules, traveler feedback, and delay notifications from various online platforms such as airport and railway station websites, social media channels, and dedicated travel disruption notification services. By analyzing this data, the system can pinpoint specific instances and locations where travelers are experiencing significant delays.

Once a potential delay is identified, the system evaluates the severity and potential duration of the delay, the number of affected travelers, and their current locations within the transportation hub. This allows for the strategic deployment of digital rewards, ensuring that they are offered to travelers when and where they can have the most significant positive impact. The choice of digital rewards—ranging from discounts on local dining and shopping to access to digital entertainment—can be tailored to the specific context of the delay, enhancing the overall effectiveness of the intervention.

Use of AI and Machine Learning to Optimize Reward Deployment: Artificial Intelligence (AI) and machine learning algorithms play a crucial role in optimizing the deployment of digital asset rewards in the system. These technologies enable the system to learn from past data on delays and user responses to different types of rewards, continually improving the accuracy and relevance of the reward offerings. Machine learning models are trained to predict the impact of various factors on traveler satisfaction during delays, such as the type of delay, the expected wait time, and the general mood of the travelers as inferred from social media sentiment analysis.

Furthermore, AI algorithms can dynamically adjust reward strategies based on real-time feedback from users. For example, if travelers begin to respond more positively to certain types of rewards in specific delay situations, the system can automatically give higher preference to those rewards in similar future scenarios. Additionally, AI can be used to segment travelers based on their profiles and past behavior, allowing for more personalized reward offerings, which are more likely to be appreciated and utilized.

By harnessing the power of AI and machine learning, the system not only enhances the immediate experience of delayed travelers but also contributes to a richer database of traveler behavior and preferences. This data is invaluable for continuously refining the approach to digital reward deployment, ensuring that the system remains at the forefront of customer engagement technology in the travel industry.

### Simple Use Case Scenarios:

Scenario 1—Airport Delay: John, a traveler, experiences a two-hour flight delay. The system detects the delay, identifies John's location at the airport, and sends him a voucher for a free coffee at a nearby cafe, sponsored by a coffee brand.

Scenario 2—Train Station Delay: Sarah, commuting by train, faces a sudden delay due to technical issues. The system sends her a discount code for a digital magazine, allowing her to download and enjoy reading while she waits.

Scenario 3—Bus Station Delay: Sarah, commuting by train, faces a sudden delay due to technical issues. The system sends her a discount code for a digital magazine, allowing her to download and enjoy reading while she waits.

### Implementation Details:

1) Geofencing Technology: Used to define virtual perimeters around transportation hubs where the system will be active. This technology ensures that only users within specific areas receive notifications.
2) Machine Learning Models: Employed to predict delays based on historical and real-time data, improving the accuracy and timeliness of the system's responses.
3) Privacy and Security Protocols: The system incorporates advanced security measures to protect user data, including encryption and anonymization techniques to ensure compliance with data protection regulations.

### Advantages of the Invention

1) Enhanced Traveler Experience: By offering timely rewards during delays, the system significantly enhances the traveler's experience.
2) Marketing Opportunities for Brands: Provides a unique platform for brands to reach consumers during vulnerable moments, potentially increasing brand loyalty and customer satisfaction.
3) Operational Insights for Transportation Hubs: The data collected by the system can provide valuable insights into common delay points and traveler behavior, aiding in operational improvements.

Modifications and Variations: While the detailed description presents a preferred embodiment, various changes and modifications can be made without departing from the scope of the invention. These could include different types of rewards, varying methods of user interaction, or adaptations to handle different types of transportation hubs or delay scenarios.
1. A method for delivering targeted digital rewards to users, the method comprising:
a detecting a delay at a transportation hub;
identifying users located within a predetermined area of the transportation hub; and
triggering digital rewards to the identified users based on the detected delay.
2. The method of claim 1, wherein the transportation hub is selected from the group consisting of:
an airport; a train station; and a bus station.
3. The method of claim 1, wherein the digital rewards are sponsored by third-party brands.
4. The method of claim 1, wherein detecting a delay includes receiving data from transportation scheduling systems.
5. The method of claim 1, further comprising sending notifications to the users' mobile devices regarding the availability of the digital rewards.
6. The method of claim 1, wherein the predetermined area is defined using geofencing technology.
7. A system for providing digital rewards to users at transportation hubs, the system comprising:
a data processing server configured to receive and analyze delay data from transportation entities;
a mobile application configured to communicate with the data processing server to receive notifications of digital rewards; and
a user database for storing user location and preference information.
8. The system of claim 7, wherein the data processing server uses machine learning models to predict transportation delays.
9. The system of claim 7, wherein the digital rewards include at least one of: discount vouchers; free or discounted products; and exclusive content access.
10. The system of claim 7, wherein the mobile application is configured to allow users to redeem digital rewards directly through the application.
11. The system of claim 7, further comprising a reward database containing information regarding the terms and availability of digital rewards from multiple brands.
12. A computer program product comprising a computer-readable medium having computer-readable program code embodied therewith, the program code executable by a processor to perform a method for providing digital rewards to users at transportation hubs, the method comprising:
steps according to any one of claims 1-5.
13. The method of claim 1, wherein the step of triggering digital rewards is based on user preferences stored in a user profile.
14. The method of claim 1, further comprising analyzing user engagement with the digital rewards to adjust future reward offerings.
15. The method of claim 1, wherein the digital rewards are customized based on the nature of the delay.
16. The system of claim 7, wherein the mobile application provides a user interface that displays the digital rewards based on the user's current location within the transportation hub.
17. The method of claim 1, further including:
verifying user eligibility for the digital reward based on the user's travel history.
18. The system of claim 7, configured to operate with Internet of Things (IoT) devices to enhance user location accuracy.
19. The system of claim 7, wherein the mobile application includes features for user feedback on the received digital rewards.
20. The method of claim 1, wherein the digital rewards are dynamically updated based on real-time changes in the status of delays.
21. A method for delivering targeted digital rewards to users, the method comprising:
identifying a delay in any part of the transportation infrastructure, including:
runways, taxiways, check-in areas, security checkpoints, customs, and immigration areas;
identifying users affected by said delays; and
triggering digital rewards to the identified users based on their current location within the transportation hub and the nature of the delay.
22. The method of claim 21, wherein the transportation infrastructure is part of:
an airport; a train station; and a bus terminal.
23. The method of claim 21, wherein the digital rewards are triggered based on the specific location of the delay, including:
airport lounges; airport gates; train platforms; and bus boarding areas.
24. The method of claim 21, wherein the delay is due to:
weather conditions; technical issues; air traffic congestion;
security and safety inspections; crew scheduling issues;
strikes and labor disputes; regulatory delays; infrastructure issues;
high passenger volumes; medical emergencies; accidents and collisions; and unscheduled maintenance.
25. The method of claim 21, further comprising:
providing notifications about the delay and available digital rewards through a mobile application to the users' mobile devices.
26. The method of claim 21, wherein the digital rewards include:
discount vouchers; free or discounted products;
exclusive access to digital content or services; and
promotional items specific to the location of the delay.
27. The method of claim 21, further including:
adjusting the type and value of the digital rewards based on the expected duration of the delay.
28. A system for implementing the method described in claim 21, comprising:
a data processing server configured to receive and analyze delay data from multiple parts of the transportation infrastructure;
a mobile application configured to communicate with the data processing server to receive notifications of digital rewards;
a user database for storing user location and preference information; and
a reward database containing information regarding terms and availability of digital rewards from multiple brands.
29. The system of claim 28, wherein the data processing server is further configured to use machine learning algorithms to predict the likelihood and duration of delays based on historical and real-time data.
30. The system of claim 28, wherein the mobile application includes features for:
immediate redemption of digital rewards; and
real-time feedback from users regarding the rewards and their current delay experience.

### Alternative Embodiment—Hyper-Accurate Location-Based Targeting and Anonymous Interaction System for Mobile Devices

### Abstract

This invention pertains to a hyper-accurate location-based targeting and anonymous interaction system designed for mobile devices, enabling users within a shared physical space to engage in anonymous interactions while preserving their privacy. By leveraging advanced geolocation technology, participants can identify each other's virtual presence on a digital map, interact through digital assets, and engage in various forms of communication without disclosing personal information unless desired. This system introduces a novel approach to social interactions and digital asset exchanges, enhancing user experiences and opening new commercial opportunities.

The core of this invention lies in its hyper-accurate location-based targeting technology, which precisely identifies and records the positions of participating mobile devices within a defined area. Users can choose to share their locations on a virtual map, represented by digital avatars or display IDs, which maintain their anonymity. This approach allows individuals to interact within physical spaces, such as bars or clubs, without immediately revealing their real identities. The system's versatility supports a range of user-defined policies, enabling selective sharing based on criteria such as gender or phone type.

A significant feature of this invention is its ability to enable interactions between users through digital assets. The first user, upon identifying a second user within visual line of sight, can send digital gifts, coupons, non-fungible tokens (“NFTs”), promo codes, currency, vouchers, or similar digital entitlements to the second user. This exchange occurs without the need for the first user to disclose their identity unless they choose to do so. Similarly, the recipient can accept or reject the digital asset without revealing their own personal information. This unique capability fosters positive interactions in real-life settings while maintaining user privacy.

For instance, consider a scenario in which an individual is at a bar and notices someone they are interested in across the room. Using the system, they can identify the person's digital avatar on their mobile device's map and send a digital coupon for a free drink. The recipient can accept or decline the offer and choose whether to respond with their contact information or a simple thank you. This example illustrates how the invention facilitates social interactions in a non-intrusive, privacy-respecting manner.

The invention also incorporates a comprehensive digital wallet system, enabling users to purchase, store, and share digital assets and entitlements seamlessly. This feature is crucial for managing the various digital interactions and transactions facilitated by the system. Additionally, an in-system communication channel, supporting text, voice, or other forms of messaging, enhances user interaction and engagement.

The ability to share photos and videos within the system adds another layer of interaction, allowing users to communicate more effectively and share moments or information. The system also employs data collection and scraping techniques to gather environmental and user data, ensuring smooth and efficient service delivery. This data-driven approach allows for real-time adjustments and optimizations, enhancing user experience.

Furthermore, the integration of new forms of artificial intelligence (“AI”) within the system provides intelligent suggestions for user pairings and interactions. By analyzing user behavior, preferences, and environmental factors, the AI can recommend potential matches and interaction opportunities within a shared physical space. This feature enhances the likelihood of meaningful connections and positive interactions among users.

The commercial potential of this invention is significant, offering businesses opportunities to engage customers in novel ways. For example, bars, clubs, and event venues can use the system to promote special offers, facilitate social interactions, and enhance overall customer experience. Brands can also leverage the technology for targeted marketing campaigns, delivering personalized promotions and rewards to users based on their location and preferences.

From a technical perspective, the implementation of hyper-accurate location-based targeting involves the use of advanced geolocation technologies, such as GPS, Wi-Fi triangulation, Bluetooth beacons, visual marker mapping, or a combination thereof. These technologies work in concert to provide precise location data, ensuring the accuracy and reliability of the system. The integration of these technologies requires robust software algorithms to process and interpret the location data, ensuring real-time updates and seamless user experiences.

The anonymous interaction component relies on secure encryption methods to protect user identities and data. By anonymizing user information and utilizing digital avatars or display IDs, the system ensures that personal details are not exposed during interactions. This approach addresses privacy concerns and builds user trust, which is essential for the widespread adoption of technology.

In terms of user experience, the system is designed to be intuitive and user-friendly. The digital map interface provides a clear and interactive representation of the physical space, allowing users to easily identify and interact with others. The process of sending and receiving digital assets is streamlined, ensuring that users can engage with the system effortlessly. Customizable privacy settings empower users to control their level of interaction and information sharing, catering to individual preferences and comfort levels.

The invention also addresses various implementation challenges, such as ensuring the accuracy of location data in diverse environments, managing data privacy and security, and providing a scalable infrastructure to support a large number of users. Solutions to these challenges include the use of hybrid location technologies, advanced encryption protocols, and cloud-based infrastructure for scalability and reliability.

In conclusion, this invention represents a groundbreaking advancement in location-based targeting and anonymous interaction technologies. By combining hyper-accurate geolocation, secure anonymity, and versatile digital asset exchanges, the system offers a unique and valuable service for social interactions and commercial applications. The ability to facilitate positive, privacy-respecting interactions within shared physical spaces opens new avenues for user engagement, marketing, and customer experiences. This invention not only addresses current limitations in location-based services but also sets the stage for future innovations in digital social interactions and commerce.

### Overview

Problem Addressed: In today's interconnected world, mobile devices have become an integral part of our social lives. However, despite the advancements in technology, there are still significant challenges in facilitating seamless and private social interactions in real-life physical spaces. Traditional methods of interaction often require disclosing personal information upfront, which can deter people from engaging in social interactions due to privacy concerns. Moreover, existing location-based services lack the accuracy and real-time capabilities needed to support dynamic, in-person interactions effectively.

The main problems addressed by this invention include:
1. Privacy Concerns: Users are often hesitant to engage in social interactions because of the need to disclose personal information, which can lead to privacy breaches and unwanted attention.
2. Accuracy of Location-Based Services: Current location-based technologies often fail to provide the precision needed to accurately identify users in close proximity, especially in crowded or indoor environments.
3. Lack of Seamless Interaction: Existing platforms do not offer a streamlined way for users to interact with each other anonymously and exchange digital assets in real time.
4. Engagement in Physical Spaces: There is a lack of technology that effectively bridges the gap between digital interactions and real-life social engagements, making it challenging for users to connect in meaningful ways while in shared physical spaces.

Innovative Solution: The proposed invention offers a comprehensive solution to these problems through the development of a hyper-accurate location-based targeting and anonymous interaction system for mobile devices. This system is designed to enhance social interactions in physical spaces while preserving user privacy and providing a seamless user experience. The key components of the innovative solution include:
1) Hyper-Accurate Location-Based Targeting Technology: This technology utilizes a combination of GPS, Wi-Fi triangulation, Bluetooth beacons, visual marker mapping, and analogous technologies to provide precise location data. This ensures that users' positions are accurately recorded and represented on a virtual map.
2) Anonymity through Digital Avatars and Display IDs: Users can share their locations on a digital map using avatars or display IDs, maintaining anonymity while interacting with others. This allows users to engage in social interactions without immediately revealing their real identities.
3) Real-Time Digital Asset Exchange: The system enables users to send and receive digital assets, such as coupons, NFTs, promo codes, and virtual gifts, in real time. This exchange can occur without disclosing personal information, offering a secure and private way to interact.
4) User-Defined Privacy Policies: Users can set specific privacy preferences, such as sharing their location only with certain groups (e.g., opposite sex, specific phone types). This flexibility allows users to control their interactions based on their comfort levels.
5) Integrated Wallet and Communication Systems: The invention includes a digital wallet for managing assets and an in-system communication channel for text, voice, and multimedia interactions. This integration ensures a cohesive and user-friendly experience.
6) AI-Driven Interaction Suggestions: The system leverages artificial intelligence to analyze user behavior and preferences, providing intelligent suggestions for potential interactions and connections within the shared physical space.

Technical Advantages: The technical advantages of this invention are numerous, addressing the limitations of existing technologies and providing a robust platform for social interactions and digital asset exchanges. These advantages include:
1) Precision in Location Tracking: By combining multiple geolocation technologies, the system achieves high accuracy in tracking users' positions, even in challenging environments like crowded indoor spaces. This precision is critical for enabling reliable interactions.
2) Scalability and Real-Time Capabilities: The system is designed to handle a large number of users simultaneously, providing real-time updates and interactions. This scalability ensures that the platform can support diverse applications and large user bases.
3) Enhanced Privacy and Security: The use of digital avatars and display IDs, coupled with advanced encryption protocols, ensures that users' personal information remains secure. This focus on privacy builds trust and encourages user participation.
4) Seamless Integration of Digital Assets: The integrated wallet system allows for easy management and exchange of digital assets, facilitating diverse interactions and transactions. This capability enhances the utility and appeal of the platform.
5) AI-Powered User Engagement: The incorporation of AI for interaction suggestions enhances user engagement by providing relevant and timely recommendations. This intelligent approach increases the likelihood of meaningful connections and positive experiences.

Commercial Potential: The commercial potential of this invention is substantial, offering numerous opportunities for businesses and brands to engage with customers in innovative ways. The key areas of commercial potential include:
1) Social and Entertainment Venues: Bars, clubs, and event venues can leverage the system to enhance customer experiences by facilitating social interactions and promoting special offers. This can lead to increased customer satisfaction and loyalty.
2) Targeted Marketing and Promotions: Brands can use the hyper-accurate location-based targeting technology to deliver personalized promotions and rewards to users based on their location and preferences. This targeted approach can drive higher engagement and conversion rates.
3) Digital Asset Marketplaces: The platform can support a marketplace for digital assets, where users can buy, sell, and trade various digital items such as NFTs, coupons, and virtual gifts. This opens new revenue streams for businesses and creators.
4) Event Management and Coordination: Event organizers can use the system to facilitate attendee interactions, coordinate activities, and distribute digital assets during events. This can enhance event experiences and provide valuable data insights.
5) Retail and Hospitality Applications: Retail stores and hospitality businesses can implement the system to offer personalized services and rewards to customers, improving customer experience and driving repeat business.
6) Data Monetization and Analytics: The data collected by the system can be anonymized and analyzed to provide insights into user behavior, preferences, and trends. Businesses can leverage these insights for strategic decision-making and targeted marketing efforts.

User Experience and Interaction: The user experience is central to the success of this invention, and the system is designed to be intuitive, engaging, and user-friendly. The main aspects of user experience and interaction include:
1) Interactive Digital Map: The digital map interface provides a clear and engaging representation of the physical space, allowing users to easily identify and interact with others. The map is updated in real-time, ensuring accurate and current information.
2) Customizable Privacy Settings: Users have control over their privacy preferences, allowing them to set specific criteria for sharing their location and interacting with others. This customization empowers users to engage in a way that aligns with their comfort levels.
3) Streamlined Asset Exchange: The process of sending and receiving digital assets is designed to be quick and effortless. Users can easily select and transfer digital items, enhancing the convenience and appeal of the platform.
4) Integrated Communication Channels: The system supports various forms of communication, including text, voice, and multimedia messaging. This integration allows users to interact in diverse ways, catering to different preferences and situations.
5) AI-Enhanced Interactions: The AI-driven interaction suggestions provide users with relevant and timely recommendations, enhancing their experience and increasing the likelihood of meaningful connections.
6) Rich Media Sharing: The ability to share photos and videos adds a dynamic element to interactions, allowing users to communicate more effectively and share experiences in real-time.

Implementation Challenges and Solutions: Implementing this innovative system involves addressing several technical and operational challenges. The main challenges and their solutions include:
1) Accuracy of Location Data: Ensuring high accuracy in location tracking, especially in crowded or indoor environments, is a critical challenge. The solution involves the use of a hybrid approach combining GPS, Wi-Fi triangulation, Bluetooth beacons, visual marker mapping, and analogous technologies to provide precise and reliable location data.
2) Data Privacy and Security: Protecting user data and maintaining privacy is paramount. The system employs advanced encryption protocols and anonymization techniques to safeguard personal information. Regular security audits and updates ensure the integrity of the platform.
3) Scalability and Performance: The system must handle a large number of users and provide real-time interactions. Implementing a cloud-based infrastructure with scalable resources and load-balancing mechanisms ensures that the platform can support high traffic and maintain performance.
4) User Adoption and Engagement: Encouraging users to adopt and engage with the platform requires a compelling value proposition and seamless user experience. Extensive user testing, intuitive design, and effective marketing strategies are employed to drive adoption and engagement.
5) Interoperability with Existing Technologies: Integrating the system with existing mobile devices and technologies requires compatibility and flexibility. The platform is designed to be device-agnostic, supporting various operating systems and hardware configurations to ensure broad accessibility.
6) Regulatory Compliance: Ensuring compliance with data protection and privacy regulations is essential. The system adheres to relevant legal frameworks, such as GDPR and CCPA, and incorporates compliance mechanisms to meet regulatory requirements.

Conclusion: In conclusion, this invention represents a significant advancement in the field of location-based targeting and anonymous interaction technologies. By combining hyper-accurate geolocation, secure anonymity, and seamless digital asset exchanges, the system addresses critical challenges in social interactions and provides a unique and valuable service for users and businesses alike. The technical advantages, commercial potential, and user-centric design position this invention as a pioneering solution in the market.

The ability to facilitate positive, privacy-respecting interactions within shared physical spaces opens new avenues for user engagement, marketing, and customer experiences. The invention not only addresses current limitations in location-based services but also sets the stage for future innovations in digital social interactions and commerce. By providing a robust platform that enhances social interactions, protects user privacy, and offers diverse commercial opportunities, this invention has the potential to transform the way people connect and interact in the digital age.

### FIELD OF THE INVENTION

The present invention is situated at the intersection of location-based services (“LBS”), mobile communication technologies, digital asset management, and privacy-enhancing technologies. Specifically, it addresses the development of a hyper-accurate location-based targeting system integrated with anonymous interaction capabilities for mobile devices. This system allows users within a shared physical space to identify, interact, and exchange digital assets without disclosing personal identities, leveraging advanced geolocation technologies, encryption methods, artificial intelligence, and integrated digital wallets. The invention's primary application areas include social networking, marketing, event management, retail, and hospitality, with significant implications for enhancing user privacy, engagement, and commercial interactions in real-time.

Location-Based Services: Location-based services provide information and functionality tailored to the user's geographic location, utilizing technologies such as GPS, Wi-Fi, Bluetooth, visual marker mapping, cellular network triangulation, and analogous technologies. These services have revolutionized navigation, social networking, marketing, and many other fields. However, current LBS solutions often face challenges in accuracy, real-time data processing, and privacy, particularly in complex environments like indoor venues or densely populated urban areas.

The present invention enhances the capabilities of LBS by employing a multi-faceted approach to geolocation. It combines GPS, Wi-Fi triangulation, Bluetooth beacons, visual marker mapping, cellular network triangulation, and analogous technologies to deliver accurate location data. GPS offers broad outdoor coverage, while Wi-Fi triangulation improves indoor accuracy by using the signal strengths from multiple Wi-Fi access points. Bluetooth beacons further refine location precision by emitting signals detectable by nearby mobile devices, enabling fine-grained tracking even in crowded spaces.

This hybrid approach ensures users' positions are accurately recorded and updated in real-time, addressing the limitations of traditional LBS technologies. This precise tracking is crucial for enabling reliable and meaningful interactions within shared physical spaces, forming the backbone of the invention's functionality.

Mobile Communication Technologies: Mobile communication technologies encompass the systems and protocols that allow mobile devices to connect and interact over various networks, including cellular, Wi-Fi, and Bluetooth. These technologies facilitate the exchange of data and enable real-time interactions, which are essential for the present invention's operation.

The invention leverages these technologies to create a seamless communication platform where users can interact and exchange digital assets without compromising their privacy. Cellular networks provide wide-area connectivity, while Wi-Fi and Bluetooth offer high-speed local connections, ensuring robust and reliable data transmission. The integration of these communication channels supports the real-time requirements of the system, enabling users to engage in dynamic interactions regardless of their location.

Digital Asset Management: Digital asset management involves the creation, storage, distribution, and exchange of digital assets such as coupons, vouchers, non-fungible tokens, virtual currencies, and other digital entitlements. As digital transactions become increasingly prevalent, the ability to manage and transfer these assets securely and efficiently is paramount.

The invention incorporates a comprehensive digital wallet system that allows users to manage their digital assets seamlessly. This wallet supports various types of assets, including digital coupons for discounts, NFTs representing unique digital items, virtual currencies for transactions, and promotional codes for special offers. Users can purchase, store, and transfer these assets within the platform, facilitating diverse interactions and transactions.

The wallet system is designed to be user-friendly, with intuitive interfaces for managing assets and performing transactions. Advanced encryption techniques ensure that all transactions are secure, protecting users' assets and personal information from unauthorized access. This secure and efficient digital asset management system enhances the platform's utility and appeal, making it an essential component of the invention.

Privacy-Enhancing Technologies: Privacy concerns are a significant barrier to the widespread adoption of location-based services and social networking platforms. Users are often reluctant to share their location or personal information due to fears of privacy breaches and misuse of their data. The present invention addresses these concerns through robust privacy-enhancing technologies.

One of the core privacy features is the use of digital avatars or display IDs to represent users on the platform. Instead of sharing their real names or contact information, users can interact using these pseudonymous identities, maintaining anonymity while engaging in social interactions. This approach allows users to participate in the platform's activities without revealing their true identities, significantly reducing privacy risks.

Advanced encryption methods protect all data transmitted within the platform, including location data, digital asset exchanges, and communication messages. This ensures that sensitive information remains secure and private, preventing unauthorized access and data breaches. Additionally, the platform provides granular privacy controls, allowing users to define who can see their location and interact with them. These controls can be customized based on various criteria, such as only sharing location with friends or restricting interactions to specific groups.

By combining anonymity with strong encryption and user-controlled privacy settings, the invention creates a secure and trustworthy environment for social interactions and digital transactions. This focus on privacy protection is crucial for building user confidence and encouraging participation in the platform.

Artificial Intelligence Integration: Artificial intelligence plays a vital role in enhancing the platform's functionality and user experience. The invention incorporates AI algorithms to analyze user behavior, preferences, and environmental factors, providing intelligent suggestions for interactions and connections.

AI-driven behavioral analysis helps the system understand users' interaction patterns, preferences, and social behaviors. By analyzing this data, the platform can make personalized recommendations, such as suggesting potential matches, highlighting interesting events, or recommending digital assets that might be of interest. This personalization enhances user engagement and satisfaction, making interactions more relevant and enjoyable.

Environmental factors, such as location, time of day, and crowd density, are also considered by the AI algorithms. This allows the platform to tailor its suggestions to the specific context, improving the relevance and effectiveness of the recommendations. For example, the AI might suggest interactions with nearby users during a busy event or recommend quieter locations for private conversations.

The AI's ability to continuously learn and adapt to users' preferences ensures that the recommendations become increasingly accurate and personalized over time. This dynamic and intelligent approach enhances the user experience and encourages ongoing engagement with the platform.

Application Areas: The present invention has broad applicability across various fields and industries, providing unique benefits and capabilities that address current limitations in location-based services, mobile communication, and digital asset management.

Social Networking and Entertainment Venues: Social networking platforms and entertainment venues, such as bars, clubs, and event spaces, can leverage the system to enhance customer experiences and facilitate social interactions. By providing a platform for anonymous and secure interactions, these venues can create a more engaging and enjoyable environment for their patrons.
1) Promotional Opportunities: Venues can use the system to distribute digital promotions and rewards, encouraging customer engagement and loyalty. For example, a club might offer digital drink coupons to new visitors or provide exclusive promotions to frequent patrons.
2) Enhanced Social Interactions: The system enables patrons to interact with each other anonymously, reducing social barriers and encouraging positive interactions. This can lead to a more vibrant and dynamic social scene within the venue.

Targeted Marketing and Promotions: Brands and businesses can utilize the hyper-accurate location-based targeting technology to deliver personalized promotions and rewards to users based on their location and preferences. This targeted approach can drive higher engagement and conversion rates, offering a valuable tool for marketers.
1) Location-Based Advertising: Businesses can deliver advertisements and promotions to users who are in close proximity to their locations. For example, a restaurant might send a digital coupon to nearby users during lunchtime, encouraging them to visit.
2) Personalized Offers: By analyzing user behavior and preferences, brands can create highly personalized offers that resonate with individual users. This can increase the effectiveness of marketing campaigns and drive customer satisfaction.

Event Management and Coordination: Event organizers can use the system to facilitate attendee interactions, coordinate activities, and distribute digital assets during events. This can enhance event experiences and provide valuable data insights for organizers.
1) Attendee Engagement: The system can be used to encourage interactions among event attendees, creating a more interactive and engaging event experience. For example, attendees might exchange digital gifts or participate in location-based challenges.
2) Activity Coordination: Organizers can use the platform to coordinate activities and provide real-time updates to attendees. This includes scheduling notifications, location-based alerts, and interactive maps.

Retail and Hospitality Applications: Retail stores and hospitality businesses can implement the system to offer personalized services and rewards to customers, improving customer experience and driving repeat business.
1) Personalized Shopping Experiences: Retailers can use the system to provide personalized shopping experiences, such as recommending products based on user preferences and location within the store. This can enhance customer satisfaction and increase sales.
2) Hospitality Services: Hotels and resorts can leverage the platform to offer personalized services and promotions to guests. This includes providing location-based recommendations for activities, dining options, and local attractions.

Digital Asset Marketplaces: The platform can support a marketplace for digital assets, where users can buy, sell, and trade various digital items such as NFTs, coupons, and virtual gifts. This creates new revenue streams for businesses and provides users with diverse interaction opportunities.
1) NFT Gifting, Exchanging, or Trading: Users can create and gift, exchange, or trade non-fungible tokens within the platform, offering unique digital items and collectibles. This can include artwork, virtual real estate, and other valuable digital assets.
2) Coupon and Voucher Exchange: The system allows users to exchange digital coupons and vouchers, facilitating a secondary market for promotional items. This can enhance the value of digital promotions and provide users with more flexibility.

Data Monetization and Analytics: The data collected by the system can be anonymized and analyzed to provide insights into user behavior, preferences, and trends. Businesses can leverage these insights for strategic decision-making and targeted marketing efforts.
1) Behavioral Analytics: Analyzing user interactions and preferences can provide valuable insights into customer behavior, helping businesses optimize their offerings and marketing strategies.
2) Market Research: The platform can be used to conduct market research, gathering data on user preferences and trends. This information can inform product development and marketing campaigns.

Conclusion: The field of the present invention encompasses a wide range of applications and technologies, providing a comprehensive solution for hyper-accurate location-based targeting, anonymous interactions, and digital asset management. By addressing critical challenges in accuracy, privacy, and real-time interactions, the invention offers significant advancements in location-based services and mobile communication.

The integration of advanced geolocation technologies, secure anonymity mechanisms, real-time interaction capabilities, and artificial intelligence sets this invention apart from existing solutions. Its broad applicability across social venues, marketing, retail, hospitality, events, and data analytics highlights its potential to transform various industries and enhance user experiences.

In summary, the present invention represents a pioneering approach to location-based services and digital interactions, offering a unique and valuable platform for modern social and commercial applications. Its innovative features and comprehensive capabilities position it as a leading solution in the evolving digital landscape.

### Background

The Evolution of Location-Based Services: Location-based services have transformed the way we interact with the world around us. From early GPS-based navigation systems to sophisticated apps that leverage geolocation data, LBS have enabled a plethora of applications across various sectors including transportation, social networking, marketing, and public safety.

Early Developments in LBS: The inception of LBS dates back to the advent of the Global Positioning System (“GPS”) in the 1970s, originally developed for military purposes. By the 1990s, GPS technology became available for civilian use, leading to the development of consumer-grade GPS devices. These devices allow for basic navigation, helping users find routes and track their locations.

Integration with Mobile Technology: The real breakthrough for LBS came with the proliferation of mobile phones equipped with GPS capabilities. By the early 2000s, mobile phones began to integrate GPS chips, allowing users to access location-based services on-the-go. This convergence of mobile technology and GPS spurred the development of applications that could provide location-specific information and services.

Emergence of Smartphones and Apps: The introduction of smartphones revolutionized LBS. Smartphones combined GPS with internet connectivity, powerful processors, and versatile app ecosystems. This combination enabled developers to create innovative LBS applications that could provide real-time location data, interactive maps, and location-based recommendations. Apps like Google Maps, Foursquare, and Uber exemplify the transformative impact of LBS in our daily lives.

Technological Advancements: Advancements in geolocation technologies have significantly enhanced the accuracy and functionality of LBS. Apart from GPS, technologies like Wi-Fi triangulation, Bluetooth beacons, Bluetooth, visual marker mapping, cellular network triangulation, and analogous technologies have been developed to provide more precise indoor location tracking. Wi-Fi triangulation uses the signal strength of multiple Wi-Fi access points to determine a user's location, while Bluetooth beacons emit signals that can be detected by nearby devices to pinpoint their positions accurately.

Challenges in Existing Location-Based Services: Despite the significant progress in LBS, several challenges remain. These challenges include accuracy, real-time data processing, privacy concerns, and user engagement, particularly in dynamic and complex environments such as indoor venues or densely populated areas.

Accuracy: GPS technology, while effective outdoors, often struggles with accuracy in indoor environments or urban canyons where signals can be obstructed by buildings and other structures. Wi-Fi triangulation, Bluetooth beacons, and visual marker mapping have improved indoor accuracy, but these technologies also have limitations. Wi-Fi triangulation relies on the density and distribution of access points, which can vary widely. Bluetooth beacons require careful placement and maintenance to ensure consistent performance.

Real-Time Data Processing: Location data needs to be processed and updated in real-time to provide meaningful interactions and services. This requires robust and efficient algorithms capable of handling large volumes of data with minimal latency. Many existing LBS solutions face challenges in maintaining real-time accuracy and responsiveness, especially in environments with high user density.

Privacy Concerns: Privacy is a major concern for users of location-based services. Sharing location data can expose users to risks such as stalking, data breaches, and unauthorized tracking. Many users are reluctant to share their location data due to these privacy concerns, limiting the adoption and effectiveness of LBS. Ensuring data privacy and security is crucial for building user trust and encouraging widespread use of location-based services.

User Engagement: Engaging users in meaningful and positive interactions through LBS is challenging. Existing platforms often lack the ability to facilitate real-time, context-aware interactions that are both engaging and privacy-respecting. Users need intuitive interfaces and features that make it easy to interact with others and access location-based services without compromising their privacy.

The Role of Mobile Communication Technologies: Mobile communication technologies play a pivotal role in the functionality of LBS. These technologies enable the real-time exchange of data and interactions among users, forming the backbone of modern location-based services.

Cellular Networks: Cellular networks provide wide-area connectivity, allowing mobile devices to connect and exchange data over long distances. The evolution of cellular technology from 2G to 4G and now 5G has significantly enhanced the speed and reliability of mobile communications. 5G, in particular, promises ultra-low latency and high-speed data transmission, enabling more responsive and robust LBS applications.

Wi-Fi: Wi-Fi offers high-speed local connectivity, making it ideal for indoor environments and areas with dense user populations. Wi-Fi triangulation can be used to enhance the accuracy of location tracking indoors, complementing GPS and cellular data.

Bluetooth: Bluetooth technology is essential for close-range communication and precise indoor location tracking. Bluetooth beacons, which emit signals detectable by nearby mobile devices, can be strategically placed within venues to provide fine-grained location data. This technology is particularly useful for applications that require high accuracy in confined spaces.

Integration of Communication Technologies: The integration of these communication technologies is crucial for the seamless operation of LBS. Combining cellular, Wi-Fi, and Bluetooth technologies ensures that location data is accurate and reliable across different environments. This hybrid approach enhances the robustness and versatility of location-based services, making them more effective and user-friendly.

Digital Asset Management in the Digital Economy: The digital economy has seen a rapid rise in the creation, distribution, and exchange of digital assets. These assets include digital coupons, vouchers, NFTs, virtual currencies, and other forms of digital entitlements. Effective digital asset management is crucial for facilitating secure and efficient transactions in the digital economy.

Digital Coupons and Vouchers: Digital coupons and vouchers have become popular tools for businesses to offer promotions and discounts. These digital assets can be easily distributed and redeemed through mobile devices, providing a convenient and cost-effective way for businesses to engage with customers.

Non-Fungible Tokens: NFTs represent unique digital items that can be owned and traded on blockchain platforms. They have gained significant attention in various fields, including art, entertainment, and virtual real estate. NFTs offer a new way for creators to monetize their digital content and for consumers to own and trade unique digital assets.

Virtual Currencies: Virtual currencies are digital representations of value that can be used for transactions within specific platforms or ecosystems. They provide a flexible and secure means of payment and can be easily transferred between users. Virtual currencies are commonly used in online gaming, social media platforms, and other digital services.

Secure and Efficient Digital Asset Management: Managing digital assets securely and efficiently requires robust systems that can handle various types of assets and transactions. This includes secure storage solutions, reliable transaction processing, and user-friendly interfaces for managing assets. Encryption and authentication mechanisms are essential to protect digital assets from unauthorized access and ensure the integrity of transactions.

Privacy-Enhancing Technologies: Privacy is a critical concern for users of digital services, especially in the context of location-based services and social networking. Privacy-enhancing technologies aim to protect users' personal information and ensure their privacy while allowing them to engage with digital services.

Anonymity: Anonymity is a key aspect of privacy protection. By allowing users to interact using pseudonymous identities, digital services can reduce the risk of privacy breaches. Digital avatars or display IDs can serve as public-facing identities, enabling users to participate in social interactions without revealing their real names or contact information.

Encryption: Encryption is essential for securing data transmitted over digital networks. Advanced encryption techniques protect sensitive information, such as location data and digital asset transactions, from unauthorized access. Encrypted communication channels ensure that data remains private and secure during transmission.

User-Controlled Privacy Settings: Providing users with control over their privacy settings is crucial for building trust and encouraging engagement. Granular privacy controls allow users to define who can see their location, interact with them, and access their personal information. These settings can be customized based on various criteria, such as only sharing location with friends or restricting interactions to specific groups.

Regulatory Compliance: Compliance with data protection regulations, such as the General Data Protection Regulation (“GDPR”) and the California Consumer Privacy Act (“CCPA”), is essential for protecting user privacy. Digital services must implement compliance mechanisms to ensure that they adhere to these regulations and protect users' personal data.

The Role of Artificial Intelligence: Artificial intelligence plays a transformative role in enhancing the functionality and user experience of digital services. AI algorithms can analyze large volumes of data, identify patterns, and make intelligent recommendations, improving the relevance and effectiveness of digital interactions.

Behavioral Analysis: AI-driven behavioral analysis helps digital services understand users' interaction patterns, preferences, and social behaviors. By analyzing this data, AI can make personalized recommendations, such as suggesting potential matches, highlighting interesting events, or recommending digital assets that might be of interest. This personalization enhances user engagement and satisfaction.

Context-Aware Recommendations: AI algorithms can consider contextual factors, such as location, time of day, and crowd density, to tailor recommendations to the specific context. This improves the relevance and effectiveness of the recommendations, making interactions more meaningful and engaging.

Continuous Learning and Adaptation: AI systems can continuously learn and adapt to users' preferences, providing increasingly accurate and personalized recommendations over time. This dynamic approach ensures that the user experience remains relevant and engaging, encouraging ongoing participation.

Integration of Technologies in the Present Invention: The present invention integrates advancements in location-based services, mobile communication technologies, digital asset management, privacy-enhancing technologies, and artificial intelligence to create a comprehensive solution for hyper-accurate location-based targeting and anonymous interactions.

### 1) Hyper-Accurate Location Tracking

The invention employs a hybrid approach to geolocation, combining GPS, Wi-Fi triangulation, Bluetooth beacons, visual marker mapping, cellular network triangulation, and analogous technologies to achieve precise and reliable location tracking. This ensures that users' positions are accurately recorded and updated in real-time, enabling meaningful interactions within physical spaces.

### 2) Anonymous Interactions

Users can interact using digital avatars or display IDs, maintaining anonymity while engaging in social interactions. Advanced encryption methods protect all data transmitted within the platform, ensuring that sensitive information remains secure and private.

### 3) Real-Time Digital Asset Exchange

The platform includes a digital wallet that allows users to manage and exchange digital assets such as coupons, NFTs, promo codes, and virtual currencies. The digital wallet supports secure transactions and provides a user-friendly interface for managing assets.

### 4) AI and Machine Learning Integration

AI and machine learning algorithms analyze user behavior, preferences, and environmental factors to provide intelligent interaction suggestions and optimize the deployment of digital rewards. These algorithms continuously learn and adapt based on user interactions and feedback, ensuring that the system becomes more effective over time.

### 5) User-Controlled Privacy Settings

The platform offers granular privacy controls, allowing users to define who can see their location and interact with them. Users can set criteria such as sharing their location only with friends, specific groups, or based on attributes like gender or phone type. This empowers users to manage their data sharing preferences, enhancing their sense of control and trust in the platform.

### 6) Versatility and Scalability

The system's modular architecture and integration of various technologies ensure flexibility and scalability, making it suitable for diverse applications and large user bases. The platform can support a wide range of use case scenarios, from social networking and event promotions to retail and public safety.

### 7) Enhanced User Engagement

The system facilitates real-time interactions and exchanges of digital assets, providing a dynamic and engaging user experience. This real-time capability is crucial for applications such as event promotions and social networking. The incorporation of AI and machine learning enhances user engagement by providing intelligent interaction suggestions and optimizing reward deployment.

Challenges Addressed by the Present Invention: The present invention addresses several key challenges associated with existing location-based services and social interaction platforms. These challenges include:

### 1) Accuracy in Location Tracking

Existing LBS technologies often struggle with accuracy, particularly in indoor environments or densely populated areas. By combining GPS, Wi-Fi triangulation, Bluetooth, visual marker mapping, cellular network triangulation, and analogous technologies, the present invention achieves hyper-accurate location tracking, ensuring that users' positions are precisely recorded and updated in real-time.

### 2) Privacy and Anonymity

Privacy concerns are a major barrier to the adoption of location-based services. The present invention addresses these concerns by allowing users to interact using digital avatars or display IDs, maintaining anonymity while engaging in social interactions. Advanced encryption methods protect all data transmitted within the platform, ensuring that sensitive information remains secure and private.

### 3) Real-Time Interactions

Many existing platforms lack the capability to facilitate real-time interactions and exchanges of digital assets. The present invention enables real-time interactions and digital asset exchanges, providing dynamic and engaging user experience. This real-time capability is crucial for applications such as event promotions and social networking.

### 4) User Engagement

Engaging users in meaningful and positive interactions is challenging. The present invention enhances user engagement by providing personalized digital rewards based on user behavior and preferences. AI-driven analysis and predictive algorithms enable the system to deploy relevant and effective rewards, increasing user satisfaction and engagement.

### 5) Scalability and Flexibility

The present invention's modular architecture and integration of various technologies ensure flexibility and scalability, making it suitable for diverse applications and large user bases. This versatility allows the platform to support a wide range of use case scenarios, from social networking and event promotions to retail and public safety.

Conclusion: The present invention represents a significant advancement in the field of location-based services and digital interactions. By combining hyper-accurate location tracking, anonymous interactions, real-time data processing, and AI-driven optimization, the system addresses key challenges in privacy, engagement, and functionality. Its versatile and scalable design makes it suitable for a wide range of applications, from social networking and event promotions to retail and public safety. The integration of advanced technologies and user-centric features ensures a secure, engaging, and user-friendly platform that has the potential to transform the way people interact in shared physical spaces.

In summary, the present invention offers a comprehensive solution for hyper-accurate location-based targeting and anonymous interactions, providing significant benefits and capabilities that address current limitations in existing technologies. Its innovative features and comprehensive capabilities position it as a leading solution in the evolving digital landscape.

### Detailed Description

Functional Description: The invention revolves around a hyper-accurate location-based targeting system integrated with anonymous interaction capabilities for mobile devices. This system enables users to identify, interact, and exchange digital assets within a shared physical space without disclosing personal identities. The key components and functionalities of the system are detailed below:
1) Hyper-Accurate Location Tracking: The system utilizes a combination of GPS, Wi-Fi triangulation, Bluetooth beacons, visual marker mapping, cellular network triangulation, and analogous technologies to achieve precise location tracking. GPS provides global outdoor coverage, while Wi-Fi triangulation improves indoor accuracy by using the signal strengths from multiple Wi-Fi access points. Bluetooth beacons emit signals detectable by nearby mobile devices, enabling fine-grained tracking in crowded spaces. This hybrid approach ensures that users' positions are accurately recorded and updated in real-time.
2) Anonymous User Representation: Users are represented by digital avatars or display IDs on the platform, allowing them to interact without revealing their real identities. These avatars or IDs serve as pseudonymous identities, providing a layer of anonymity that addresses privacy concerns.
3) Real-Time Interaction and Digital Asset Exchange: The system facilitates real-time interactions and exchanges of digital assets such as coupons, NFTs, promo codes, and virtual currencies. Users can send and receive these assets without disclosing their identities. The process is streamlined to be quick and user-friendly, ensuring seamless engagement.
4) User-Defined Privacy Settings: The platform offers granular privacy controls, allowing users to define who can see their location and interact with them. Users can set criteria such as sharing their location only with friends, specific groups, or based on attributes like gender or phone type.
5) Integrated Digital Wallet: The system includes a digital wallet for managing assets. Users can purchase, store, and transfer digital assets securely. The wallet supports various types of assets and ensures secure transactions through advanced encryption techniques.
6) Communication Channels: The platform supports multiple forms of communication, including text, voice, and multimedia messaging. This allows users to interact in diverse ways, enhancing the overall user experience.
7) AI and Machine Learning Integration: Artificial intelligence and machine learning algorithms analyze user behavior, preferences, and environmental factors to provide intelligent interaction suggestions and optimize the deployment of digital rewards.

Real-Time Data Scraping for Targeting Digital Asset Rewards: The invention incorporates real-time data scraping techniques to gather and process environmental and user data, facilitating the targeting and deployment of digital asset rewards. The process involves the following steps:
1) Data Collection: The system continuously collects data from various sources, including GPS, Wi-Fi signals, Bluetooth beacons, visual marker mapping, cellular network triangulation, and analogous technologies, as well as user interactions and environmental sensors. This data is aggregated and stored in a secure database.
2) Data Processing: The collected data is processed in real-time using advanced algorithms. Location data is refined and validated to ensure accuracy, while user interaction data is analyzed to identify patterns and preferences.
3) Targeting Criteria: Based on processed data, the system establishes targeting criteria for digital asset rewards. These criteria can include user location, interaction history, behavior patterns, and preferences. The targeting criteria ensure that digital rewards are relevant and personalized.
4) Reward Deployment: Once the targeting criteria are established, the system deploys digital rewards to eligible users. This deployment is managed in real-time, ensuring that users receive rewards that are timely and contextually appropriate. For example, a user entering a specific venue might receive a digital coupon for a discount on drinks.
5) User Feedback and Optimization: The system continuously collects feedback from users regarding the effectiveness and satisfaction of the digital rewards. This feedback is used to refine the targeting criteria and improve the reward deployment process over time.

Use of AI and Machine Learning to Optimize Reward Deployment: Artificial intelligence and machine learning play a crucial role in optimizing the deployment of digital rewards. The system leverages these technologies to analyze data, predict user behavior, and make intelligent recommendations. The key aspects of AI and machine learning integration include:
1) Behavioral Analysis: Machine learning algorithms analyze user behavior and interaction patterns to understand preferences and predict future actions. This analysis helps the system identify which types of digital rewards are most likely to engage users.
2) Preference Modeling: AI algorithms create models of user preferences based on historical data and real-time interactions. These models are used to personalize digital rewards, ensuring that they align with individual user interests and needs.
3) Contextual Awareness: The system uses AI to consider contextual factors such as location, time of day, and environmental conditions. By understanding the context in which users are operating, the system can deploy digital rewards that are relevant and timely.
4) Predictive Analytics: Predictive analytics algorithms forecast user behavior and interactions based on historical and real-time data. These predictions inform the deployment of digital rewards, enhancing their effectiveness and engagement.
5) Feedback Loop: The system incorporates a continuous feedback loop where user responses to digital rewards are analyzed and used to improve future deployments. Machine learning algorithms adjust the models and criteria based on this feedback, ensuring that the system becomes more effective over time.

Simple Use Case Scenarios: The invention supports a wide range of use case scenarios that demonstrate its versatility and utility. Some simple examples include:
1) Social Interaction in a Bar: A user enters a bar and sees someone they are interested in across the room. Using the platform, they identify the person's digital avatar on their mobile device's map and send a digital coupon for a free drink. The recipient can accept or decline the offer and choose whether to respond with their contact information or a simple thank you. This scenario illustrates how the system facilitates social interactions in a non-intrusive, privacy-respecting manner.
2) Event Promotion at a Concert: During a concert, the event organizers use the platform to distribute digital vouchers for merchandise discounts to attendees in specific sections of the venue. The vouchers are deployed based on real-time location data, ensuring that attendees receive relevant offers. This enhances event experience and drives sales.
3) Retail Store Offers: A user enters a retail store and receives a notification on their mobile device about a limited-time discount on a product they have shown interest in. The offer is personalized based on their shopping history and preferences, encouraging them to make a purchase.
4) Networking at a Conference: At a professional conference, attendees can use the platform to identify and connect with others in their field. They can send digital business cards or invitations to network without revealing their personal contact information. This scenario highlights the system's ability to facilitate professional networking in a secure and efficient manner.
5) Fitness and Wellness Program: A gym uses the platform to engage members by sending digital rewards for meeting fitness goals. For example, users who complete a certain number of workouts in a month receive a digital voucher for a free health supplement. The system tracks user activity and deploys rewards based on real-time data.

Implementation Details: Implementing the invention involves several technical and operational considerations to ensure its functionality, security, and scalability. The main implementation details include:
1) System Architecture: The system is designed with a modular architecture that integrates various components such as geolocation technologies, digital wallets, communication channels, and AI algorithms. This modularity ensures flexibility and scalability, allowing the system to support a large number of users and diverse applications.
2) Data Security and Privacy: Ensuring data security and privacy is paramount. The system employs advanced encryption techniques to protect data during transmission and storage. User identities are anonymized through digital avatars or display IDs, and granular privacy controls allow users to manage their data sharing preferences.
3) Geolocation Technologies: The system integrates GPS, Wi-Fi triangulation, and Bluetooth beacons, visual marker mapping, cellular network triangulation, and analogous technologies to achieve hyper-accurate location tracking. GPS provides broad outdoor coverage, while Wi-Fi triangulation improves indoor accuracy. Bluetooth beacons are strategically placed within venues to provide fine-grained location data.
4) Real-Time Data Processing: The system processes location and interaction data in real-time using efficient algorithms and cloud-based infrastructure. This ensures that users receive timely and accurate information, and digital rewards are deployed effectively.
5) Digital Wallet Integration: The digital wallet is integrated into the platform, allowing users to manage their assets seamlessly. The wallet supports various types of digital assets and ensures secure transactions through encryption and authentication mechanisms.
6) AI and Machine Learning: AI and machine learning algorithms are integrated into the system to analyze data, predict user behavior, and optimize reward deployment. These algorithms continuously learn and adapt based on user interactions and feedback.
7) User Interface and Experience: The platform is designed with a user-friendly interface that provides intuitive navigation and interaction. The digital map interface allows users to easily identify and interact with others, while the digital wallet and communication channels are seamlessly integrated.

Advantages of the Invention: The invention offers several significant advantages over existing location-based services and social interaction platforms. These advantages include:
1) Enhanced Privacy and Anonymity: By allowing users to interact using digital avatars or display IDs, the system protects user privacy and reduces the risk of identity exposure. This encourages more users to engage with the platform.
2) Hyper-Accurate Location Tracking: The combination of GPS, Wi-Fi triangulation, and Bluetooth beacons, visual marker mapping, cellular network triangulation, and analogous technologies ensures precise and reliable location tracking, enabling meaningful interactions within physical spaces.
3) Real-Time Interactions: The system facilitates real-time interactions and exchanges of digital assets, providing a dynamic and engaging user experience. This real-time capability is crucial for applications such as event promotions and social networking.
4) Personalized Digital Rewards: AI-driven analysis and predictive algorithms enable the system to deploy personalized digital rewards based on user behavior and preferences. This increases the relevance and effectiveness of the rewards.
5) User-Controlled Privacy Settings: Granular privacy controls empower users to manage their data sharing preferences, enhancing their sense of control and trust in the platform.
6) Integrated Digital Wallet: The digital wallet provides a secure and convenient way for users to manage and exchange digital assets. This integration enhances the utility and appeal of the platform.
7) Versatility and Scalability: The system's modular architecture and integration of various technologies ensure flexibility and scalability, making it suitable for diverse applications and large user bases.
8) AI-Enhanced User Engagement: The incorporation of AI and machine learning enhances user engagement by providing intelligent interaction suggestions and optimizing reward deployment.

Modifications and Variations: The invention is designed to be flexible and adaptable, allowing for various modifications and variations to meet specific needs and applications. Some potential modifications and variations include:
1) Integration with Augmented Reality (“AR”): The platform can be enhanced with AR features, allowing users to view digital avatars and interact with others through an augmented reality interface. This can provide a more immersive and interactive experience.
2) Expansion to Wearable Devices: The system can be extended to support wearable devices such as smartwatches and AR glasses. This would enable users to access the platform and interact with others without relying solely on their mobile phones.
3) Advanced Data Analytics: The system can incorporate more advanced data analytics capabilities, such as sentiment analysis and predictive modeling, to provide deeper insights into user behavior and preferences.
4) Integration with Third-Party Services: The platform can be integrated with third-party services such as payment gateways, social media platforms, and e-commerce sites to provide additional functionalities and enhance the user experience.
5) Customizable User Interfaces: The user interface can be customized to meet the specific needs of different user groups or applications. For example, a retail version of the platform might include features tailored to shopping and product recommendations.
6) Enhanced Security Features: Additional security features, such as biometric authentication and multi-factor authentication, can be implemented to further protect user data and ensure secure transactions.
7) Localization and Internationalization: The platform can be localized and internationalized to support different languages and cultural preferences, making it accessible to a global user base.
8) Use in Public Safety and Emergency Services: The system can be adapted for use in public safety and emergency services, providing real-time location tracking and communication capabilities for first responders and emergency personnel.

Conclusion: In conclusion, the present invention represents a significant advancement in the field of location-based services and digital interactions. By combining hyper-accurate location tracking, anonymous interactions, real-time data processing, and AI-driven optimization, the system addresses key challenges in privacy, engagement, and functionality. Its versatile and scalable design makes it suitable for a wide range of applications, from social networking and event promotions to retail and public safety. The integration of advanced technologies and user-centric features ensures a secure, engaging, and user-friendly platform that has the potential to transform the way people interact in shared physical spaces.
1. A system for hyper-accurate location-based targeting and anonymous interaction for mobile devices, comprising:
a geolocation module configured to utilize GPS, Wi-Fi triangulation, and Bluetooth beacons, visual marker mapping, cellular network triangulation, and analogous technologies to determine precise user locations;
a digital avatar module enabling users to represent themselves with pseudonymous identities;
a communication module facilitating real-time interactions through text, voice, and multimedia messaging;
a digital wallet module for managing, purchasing, storing, and transferring digital assets;
an artificial intelligence module configured to analyze user behavior, preferences, and environmental data to optimize interaction suggestions and reward deployment; and
a privacy control module allowing users to define privacy settings for location sharing and interactions.
2. The system of claim 1, wherein the geolocation module is further configured to process and validate location data in real-time to ensure accuracy and reliability.
3. The system of claim 1, wherein the digital avatar module provides users with customizable avatars or display IDs to enhance anonymity.
4. The system of claim 1, wherein the communication module supports encrypted messaging to ensure the privacy and security of user communications.
5. The system of claim 1, wherein the digital wallet module supports multiple types of digital assets, including coupons, vouchers, non-fungible tokens, virtual currencies, and promotional codes.
6. The system of claim 1, wherein the artificial intelligence module utilizes machine learning algorithms to continuously learn from user interactions and feedback to improve interaction suggestions and reward deployment.
7. The system of claim 1, wherein the privacy control module provides granular settings for users to specify who can see their location and interact with them, including options based on friend lists, specific groups, gender, and phone type.
8. A method for facilitating anonymous interactions and digital asset exchanges within a shared physical space, comprising:
determining precise user locations using a combination of GPS, Wi-Fi triangulation, and Bluetooth beacons, visual marker mapping, cellular network triangulation, and analogous technologies;
allowing users to represent themselves with digital avatars or display IDs;
enabling real-time interactions and exchanges of digital assets between users;
utilizing artificial intelligence to analyze user behavior and preferences to provide personalized interaction suggestions; and
allowing users to define and manage privacy settings for location sharing and interactions.
9. The method of claim 8, further comprising encrypting all data transmissions to ensure the security and privacy of user communications and transactions.
10. The method of claim 8, wherein digital assets include at least one of the following: coupons, vouchers, non-fungible tokens, virtual currencies, and promotional codes.
11. The method of claim 8, wherein artificial intelligence is used to analyze environmental factors, such as location, time of day, and crowd density, to tailor interaction suggestions contextually.
12. The method of claim 8, further comprising collecting and processing user feedback on digital rewards to refine and optimize future reward deployment.
13. A mobile device configured to participate in a system for hyper-accurate location-based targeting and anonymous interaction, comprising:
a geolocation unit configured to determine precise location using GPS, Wi-Fi triangulation, Bluetooth, cellular network triangulation, and analogous technology signals;
a digital avatar unit for representing the user with a pseudonymous identity;
a communication unit for encrypted real-time messaging;
a digital wallet unit for managing and transacting digital assets;
an artificial intelligence unit for analyzing user data and optimizing interactions and rewards; and
a privacy control unit for managing location sharing and interaction preferences.
14. The mobile device of claim 13, wherein the geolocation unit continuously updates and validates location data to ensure accuracy.
15. The mobile device of claim 13, wherein the digital avatar unit allows users to customize their avatars or display IDs.
16. The mobile device of claim 13, wherein the communication unit supports multiple communication methods, including text, voice, and multimedia.
17. The mobile device of claim 13, wherein the digital wallet unit supports secure transactions for various digital assets, including coupons, NFTs, and virtual currencies.
18. The mobile device of claim 13, wherein the artificial intelligence unit uses machine learning to adapt and improve interaction suggestions based on user behavior and preferences.
19. The mobile device of claim 13, wherein the privacy control unit provides settings to specify visibility and interaction permissions based on user-defined criteria.
20. A non-transitory computer-readable medium containing instructions that, when executed by a processor, cause a mobile device to:
determine the precise location of the device using GPS, Wi-Fi triangulation, Bluetooth, cellular network triangulation, and analogous technology signals;
represent the user with a digital avatar or display ID;
facilitate encrypted real-time messaging and digital asset exchanges;
utilize artificial intelligence to analyze user data and optimize interactions and rewards; and
manage user privacy settings for location sharing and interactions.
21. The non-transitory computer-readable medium of claim 20, wherein the instructions further cause the device to continuously update and validate location data to ensure accuracy.
22. The non-transitory computer-readable medium of claim 20, wherein the instructions further cause the device to allow users to customize their digital avatars or display IDs.
23. The non-transitory computer-readable medium of claim 20, wherein the instructions further cause the device to support multiple communication methods, including text, voice, and multimedia.
24. The non-transitory computer-readable medium of claim 20, wherein the instructions further cause the device to securely manage and transact various digital assets, including coupons, NFTs, and virtual currencies.
25. The non-transitory computer-readable medium of claim 20, wherein the instructions further cause the device to use machine learning to adapt and improve interaction suggestions based on user behavior and preferences.
26. The non-transitory computer-readable medium of claim 20, wherein the instructions further cause the device to provide settings for users to specify visibility and interaction permissions based on user-defined criteria.

### Alternative Embodiment—Method & System for Tokenized Music Streaming Points Distribution and User-Generated Content Engagement

### Abstract

The Method & System for Tokenized Music Streaming Points Distribution and User-Generated Content Engagement (the “Platform”) described herein integrates tokenized music streaming access points with the Platform's various user-generated content (“UGC”) creators (each a “Creator”) to enhance engagement, monetization, and loyalty for music streaming services, content creators, and brands. By converting music content access points generated by music streaming services into digital tokens (“Tokenized Points”), the Platform enables both music streaming service brands (each a “Points Brand”) and non-music streaming service brands (each a “Non-Points Brand”) to distribute these Tokenized Points to the Platform's UGC viewers (each a “Viewer”) as Viewer earned virtual loot boxes (each a “Loot Box”) containing variable amount rewards therein for the Viewer engaging with the Creator's UGC posted on the Platform. In addition, advanced artificial intelligence (“AI”) drives personalized UGC recommendations, interactive features, and performance analytics, optimizing the experience for all users (e.g., Viewers, Creators, Point Brands, and Non-Point Brands). Moreover, the Platform supports multi-device compatibility and is suited to integrate TV and film-oriented streaming points, air mile loyalty points, hotel points, and retail loyalty points as part of its variable reward Loot Box mechanic.

### Field

The present invention relates to the field of digital content distribution and user engagement, particularly focusing on the use of creating and distributing tokenized points from music streaming services to incentivize the consumption and creation of UGC on the Platform. More specifically, this invention pertains to a Platform that leverages tokenized music streaming points to enhance viewer engagement, creator rewards, and brand loyalty, while also integrating advanced artificial intelligence to optimize the overall user experience.

### Background

The digital age has revolutionized how media content is consumed, created, and monetized. Music streaming services, such as Spotify, Apple Music, Amazon Music, Deezer, and Napster, have become ubiquitous, providing users with vast libraries of music accessible on-demand. These services often use (1) subscription models, where users pay a monthly fee for premium, ad-free access to music, or (2) free models supported by advertisements. Despite the growth and popularity of these services, there remains a significant challenge in converting users in the second category cited above (free, ad-supported users) into paying subscribers cited in the first category.

Additionally, other UGC systems like YouTube, TikTok, Twitch, X (Twitter), Discord, Reddit, and Instagram have empowered individuals to create and share their content, ranging from short dance videos to music covers to video game compilations to other creative works. These systems thrive on user engagement, with content creators relying on views, likes, shares, and comments to gain visibility and earn income through advertising and sponsorship deals. However, many creators struggle to monetize their content effectively, particularly those with smaller followings.

Moreover, loyalty programs have long been a staple in customer retention strategies across various industries. For example, airlines have successfully implemented loyalty programs where frequent flyers earn miles that can be redeemed for flights, upgrades, and other benefits. These programs have proven effective in maintaining customer loyalty, and perhaps more importantly have contributed to airlines increasing their revenue through partnerships with credit card companies and other businesses that purchase these loyalty air mile points in bulk from the airlines and then offer as free, gifted incentives to their own future credit card customers.

Lastly, in recent years, the concept of tokenization has gained traction, particularly with the advent of blockchain technology. Tokenization involves converting the value of an asset into a digital token that can be easily transferred, traded, or redeemed. This concept has been applied to various forms of assets, including loyalty points, allowing for greater flexibility and interoperability across different Platforms and services.

Given this background, there is an opportunity to invent a method and system that leverages and re-combines these market attributes and mechanical techniques into a unique, valuable, and implementable invention.

### Summary

The Problem to be Solved: Despite the success of loyalty programs and the widespread adoption of music streaming services and UGC systems, several challenges remain unaddressed:
1) Conversion of Free Users to Subscribers: Music streaming services face the ongoing challenge of converting free, ad-supported users into paying subscribers. Traditional marketing efforts have had limited success in achieving this conversion at scale.
2) Monetization for Content Creators: Many UGC creators struggle to monetize their content effectively. Advertising revenue and sponsorship deals are often insufficient, especially for creators with smaller audiences.
3) Engagement and Retention: Maintaining high levels of user engagement and retention is critical for both streaming services and UGC systems. Existing methods of incentivizing engagement, such as likes, comments, and shares, are often insufficient in providing sustained user interest.
4) Brand Loyalty and Customer Acquisition: Lesser-known and local brands often lack the resources to create and maintain effective loyalty programs. These brands need innovative ways to engage customers and build loyalty without incurring the significant costs and risks associated with creating their own loyalty programs.
5) Interoperability and Flexibility of Loyalty Points: Traditional loyalty programs are often siloed, limiting the ability of users to transfer or redeem points across different services. There is a need for a more flexible and interoperable system that can enhance the value and utility of loyalty points.
6) Cost of Initiating and Maintaining Free Promotional Access to Leading Music Streaming Services: Traditional methods for promoting access to music streaming services can be costly and inefficient, highlighting the need for a more cost-effective and scalable solution—and if possible—create an opportunity for music streaming services to actually generate revenue for themselves whilst promoting access to their music streaming services.

Unique Solution: The present invention addresses these challenges by introducing the Method & System for Tokenized Music Streaming Points Distribution and User-Generated Content Engagement (the “Platform”), a novel system that integrates tokenized music streaming points with user-generated content to create a dynamic and engaging UGC ecosystem that is financially enhanced compared to the status quo. The Platform also leverages advanced AI to optimize user experience, enhance content discovery, and provide personalized recommendations.

The invention operates as follows:
1) Tokenization of Music Streaming Points: Major music streaming services (each a Points Brand) tokenize their music content access points into Tokenized Points, such as Tokenized Points for access to specific genres or artists or minutes of listening time (e.g., time amounts/blocks of time, time of day, day of week, or combinations thereof). These Tokenized Points are then sold by the Points Brands to any number of Non-Points Brands, which may or may not have their own loyalty programs, and seek to engage customers through innovative means where their non-music streaming Non-Points Brands are associated with one or more music-streaming Points Brands.
2) Distribution through Loot Boxes: Non-Points Brands distribute variable reward amounts of music streaming oriented Tokenized Points via Loot Boxes on the invention. For instance, Platform Viewers may earn these Loot Boxes by watching and engaging with one or more UGC videos (e.g., Viewer watches ten UGC videos to earn one Loot Box, and needs to watch another 20 UGC videos to earn a second Loot Box, etc.). Each Loot Box contains variable rewards, including Tokenized Points, which are split equally between Viewers, Creators, and the invention system administrator.
3) AI-Driven Personalization: The Platform will. Also employ AI algorithms to analyze user behavior and preferences, providing personalized UGC recommendations to enhance viewer engagement. AI also powers interactive features, such as chatbots and virtual assistants, to assist users in real-time.

Monetization for Creators: Registered Creators can sell their collected Tokenized Points to Non-Points Brands for re-distribution within the Platform, providing an additional income stream. This system complements the micro-income aspect enjoyed by Viewers who earn Tokenized Points by engaging with content.
4) Regulatory Compliance and Value Tracking: The Platform ensures compliance with tax regulations by limiting the distribution of Tokenized Points to no more than $599 per year per Viewer from any single Non-Points Brand. Tokenized Points collected by Viewers can be redeemed for real music streaming access on leading music streaming services, with a small untokenization fee paid to the Platform administrator by the Points Brand (an untokenization or Tokenized Points “off-ramp” fee).

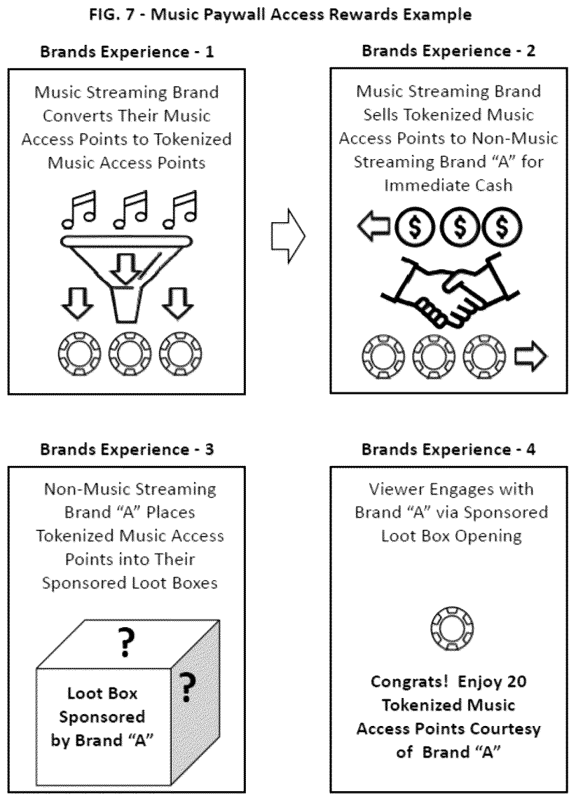

FIG. 7 is a block diagram of music paywall access rewards in accordance with one example implementation of the present disclosure.

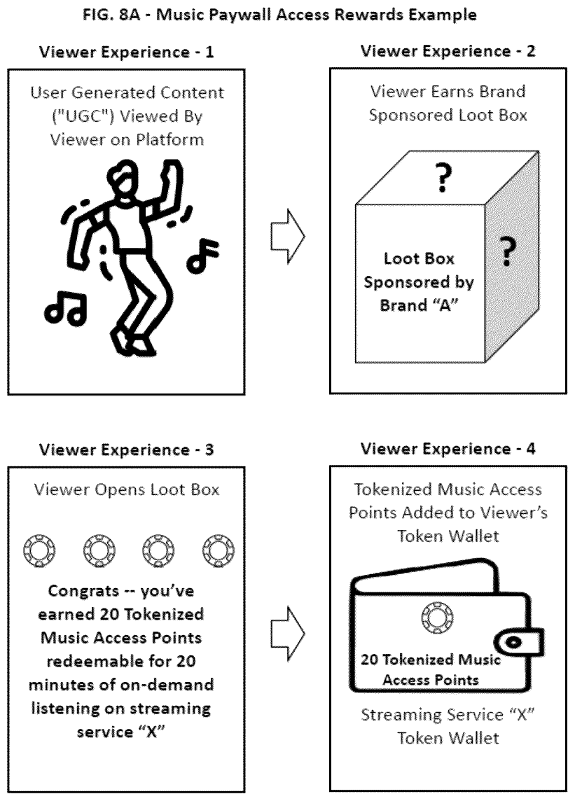

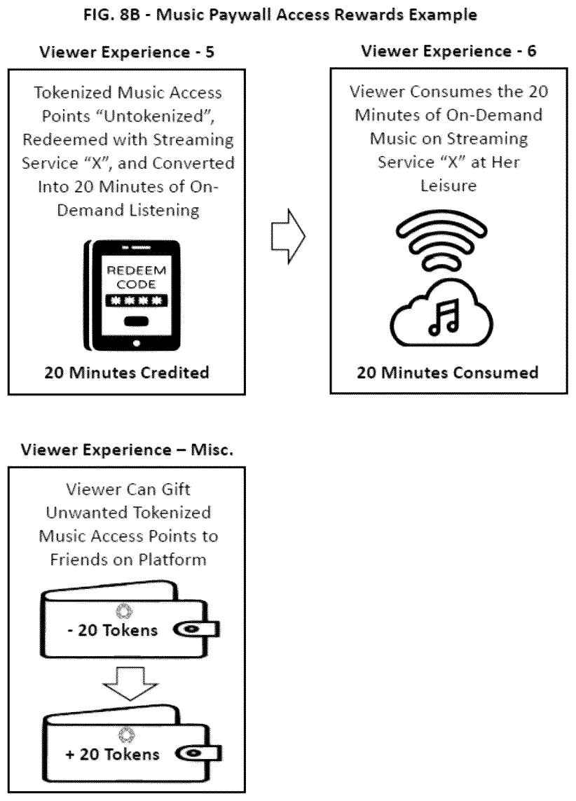

FIG. 8A is a block diagram of music paywall access rewards in accordance with another example implementation of the present disclosure.

FIG. 8B is a block diagram of music paywall access rewards in accordance with yet another example implementation of the present disclosure.

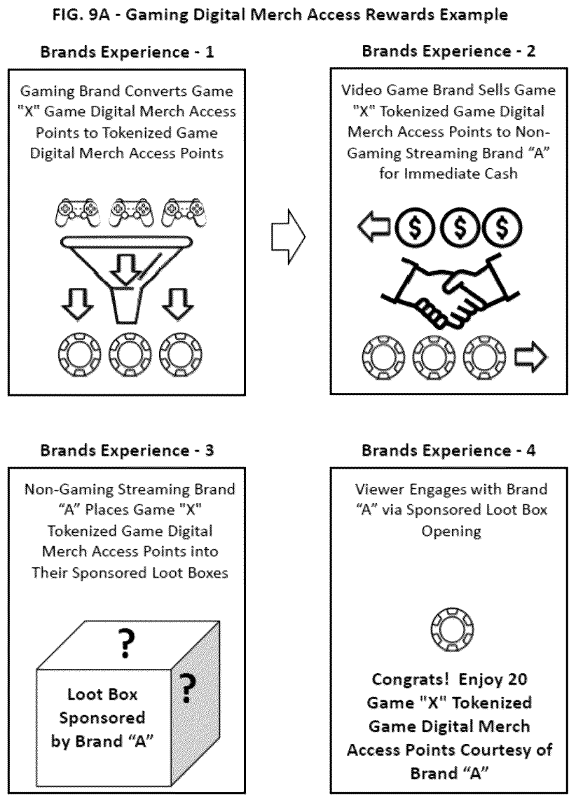

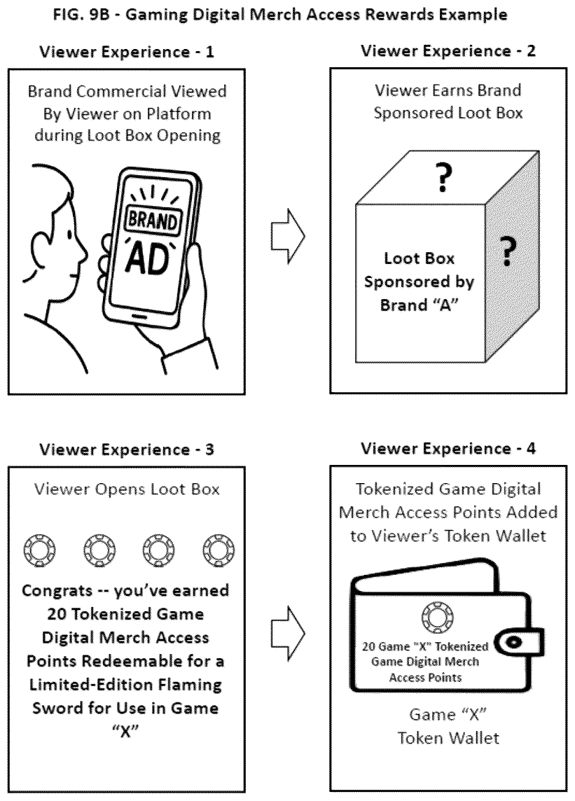

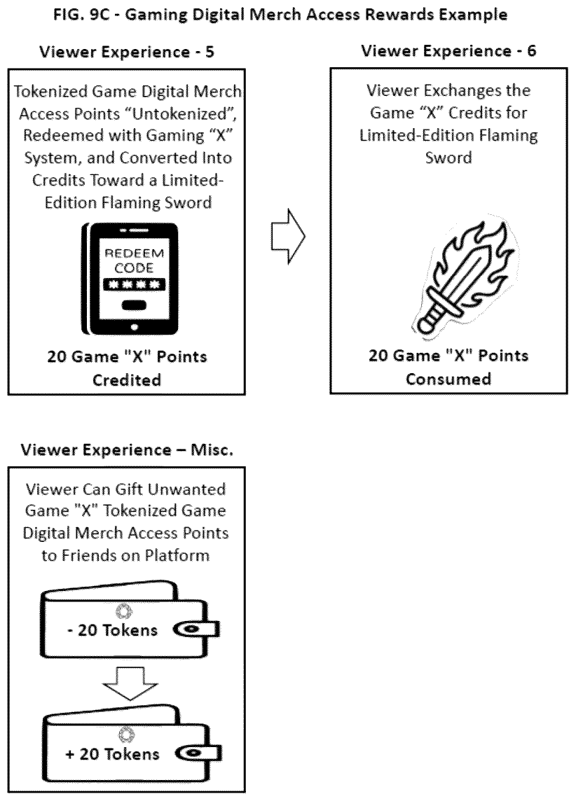

FIG. 9A is a block diagram of gaming digital merchandise access rewards in accordance with one example implementation of the present disclosure.

FIG. 9B is a block diagram of gaming digital merchandise access rewards in accordance with another example implementation of the present disclosure.

FIG. 9C is a block diagram of gaming digital merchandise access rewards in accordance with yet another example implementation of the present disclosure.

Advantages of the Invention: The invention offers several significant advantages:
1) Enhanced Conversion Rates: By providing free access to premium music streaming services through Tokenized Points, the Platform encourages ad-supported users to experience the benefits of premium on-demand services, increasing the likelihood of conversion to paid subscriptions. At the same time, the availability of collected Tokenized Points to paying subscribers is unlikely to result in the paying subscriber cancelling their service in order to replicate the same through the collection of Tokenized Points (e.g., one would expect little or no cannibalization of paid subscribers to the use of just the Platform).
2) Increased Monetization for Creators: Creators benefit from multiple revenue streams, including the sale of Tokenized Points and engagement-based rewards, making it easier for them to monetize their content effectively.
3) Higher User Engagement and Retention: Personalized content recommendations and interactive AI features enhance the user experience, leading to higher engagement and retention rates.
4) Cost-Effective Customer Acquisition for Brands: Non-Points Brands can leverage the appeal of well-known music streaming services to engage customers without the need to maintain their own costly loyalty programs. And for the Points Brands selling the Tokenized Points to the Non-Points Brands, this creates an inverse customer acquisition cost dynamic for the Points Brands, where the cost of acquiring new customers is offset by the value of the Tokenized Points sold to and distributed onward to Viewers and Creators by the Non-Points Brands (economically analogous to the airline model of airlines selling air mile points to credit card brands for a profit).
5) Interoperability and Flexibility: The tokenization of music content access points into Tokenized Points that may be collected and gifted amongst user wallets allows for greater flexibility and interoperability for all ecosystem participants, enabling users (Viewers and Creators) to redeem (off-ramp) Tokenized Points for use across different music services and enhancing the overall value of the music content access points once untokenized.
6) Regulatory Compliance: The Platform's design ensures compliance with securities, currency, and tax regulations, reducing the risk of legal issues and providing a secure environment for users and brands.

The invention therefore represents a significant innovation in the fields of digital content distribution, user engagement, and loyalty programs. By integrating tokenized music streaming points with user-generated content and leveraging advanced AI, the Platform addresses key challenges faced by music streaming services, content creators, and brands. The result is a dynamic and engaging ecosystem that enhances user experience, increases monetization opportunities, and drives customer loyalty.

### Technical Description

System Architecture: The invention comprises several integrated components, each playing a crucial role in overall functionality and user experience. The primary components include the Tokenization Engine, User Interface (“UI”), AI Personalization Engine, Content Moderation System, and the Transaction and Compliance Module.

### 1) Tokenization Engine

A) Token Generation: The Tokenization Engine converts music content access points from Points Brands (e.g., Spotify, Apple Music) into Tokenized Points. This process involves generating unique digital tokens that represent specific amounts of streaming access or other benefits.

B) Token Sale and Distribution: These Tokenized Points are sold to Non-Points Brands, which distribute them through Loot Boxes to be earned and accessed by Viewers and the contents thereof shared with Creators and the Platform administrator. The engine ensures secure and transparent transactions, utilizing blockchain technology potentially for added security and immutability.

### 2) User Interface

A) Viewer Dashboard: Provides an intuitive interface where Viewers can view available UGC, track their earned Tokenized Points, and redeem these points for off-platform music streaming access.

B) Creator Dashboard: Allows Creators to upload and manage their content, track engagement metrics, and sell their collected Tokenized Points to Non-Points Brands.

C) Brand Dashboard: Enables Non-Points Brands to purchase Tokenized Points, manage Loot Box distributions, and analyze campaign effectiveness.

### 3) AI Personalization Engine

A) Content Recommendations: Analyzes user behavior, preferences, and engagement patterns to recommend personalized UGC to Viewers, enhancing engagement and retention.

B) Interactive Features: Includes chatbots and virtual assistants to provide real-time assistance and engage users in interactive activities.

C) Performance Analytics: Offers insights into content performance for Creators, helping them optimize their content based on viewer interactions and feedback.

### 4) Content Moderation System

A) Automated Moderation: Uses AI to automatically detect and flag inappropriate or non-compliant content, ensuring a safe and high-quality environment for all users.

B) Human Oversight: Includes a team of moderators to review flagged content and handle edge cases that require human judgment.

### 5) Transaction and Compliance Module

A) Value Tracking: Monitors the total value of Tokenized Points distributed to each Viewer from each Non-Points Brand, ensuring compliance with tax regulations.

B) Compliance Reporting: Generates requisite IRS Form 1099-MISC for Creators and handles other regulatory reporting requirements.

C) Secure Transactions: Utilizes secure database or blockchain technology to ensure secure and transparent transactions between Points Brands, Non-Points Brands, Creators, and Viewers.

### Technical Workflow:

### 1) Token Generation and Sale

A) Points Brands (music streaming services) tokenize their music content access points into digital tokens (Tokenized Points) using the Tokenization Engine.

B) These Tokenized Points are sold to Non-Points Brands through a secure transaction process for cash and generates immediate new channel revenue (distinct from traditional subscription revenue and ad model revenues) for the Points Brands.

### 2) Content Creation and Upload

A) Creators produce UGC, possibly incorporating licensed music from Points Brands or their own music and upload it to the invention.

B) The Content Moderation System reviews the content for compliance with Platform guidelines.

### 3) Viewer Engagement

A) Viewers browse and engage with UGC, earning Tokenized Points through Loot Boxes distributed by Non-Points Brands.

B) The AI Personalization Engine recommends content based on viewer preferences, enhancing engagement.

### 4) Token Redemption and Sale

A) Viewers redeem Tokenized Points for music streaming access off the Platform (e.g., on Spotify or analogous music streaming system), with either the Platform user or the off-ramped music streaming system paying a small untokenization fee to the invention.

B) Registered Creators can sell their collected Tokenized Points to Non-Points Brands for redistribution, providing an additional income stream.

### 5) Compliance and Reporting

A) The Transaction and Compliance Module tracks all transactions and ensures compliance with tax regulations, generating necessary reports for IRS filings.

The invention can be expanded to include various other types of tokenized loyalty points, offering additional engagement and monetization opportunities across different industries.

### 1) TV and Film Streaming Points

A) Integration: Points Brands could include TV and film streaming services such as Netflix, Hulu, and Disney+. Tokenized Points could represent viewing hours (time amounts, time of day, day of week, or combinations thereof) or access to premium content.

B) User Engagement: Viewers earn Tokenized Points by engaging with UGC related to TV shows and movies, which can then be redeemed for streaming access.

C) Creator Benefits: Creators producing film-related content can earn and sell Tokenized Points, enhancing their revenue streams.

### 2) Air Miles and Hotel Points

A) Airline Integration: Points Brands could include major airlines, with Tokenized Points representing air miles. These points could be sold to Non-Points Brands and distributed via the invention.

B) Hotel Integration: Major hotel chains could tokenize their loyalty points, allowing Viewers to earn and redeem points for hotel stays and services.

C) User and Creator Engagement: Viewers earn air miles and hotel points by engaging with travel-related UGC, while Creators benefit from additional revenue streams by selling their collected points.

3) Misc. Retail Loyalty Points

A) Misc. Retail Integration: Points Brands could include major retail chains and online paywall services (news, podcasts, non-entertainment subscription services, etc.), with Tokenized Points representing discounts or cashback rewards.

B) User Engagement: Viewers earn misc. retail loyalty points by engaging with UGC related to shopping and lifestyle content.

C) Creator Benefits: Creators producing retail-related content can earn and sell Tokenized Points, providing additional income opportunities.

### 4) Gaming Points

A) Gaming Integration: Points Brands could include major gaming Platforms, with Tokenized Points representing in-game currency or access to premium content.

B) User Engagement: Viewers earn gaming points by engaging with gaming-related UGC, enhancing their overall gaming experience.

C) Creator Benefits: Creators producing gaming content can earn and sell Tokenized Points, providing a significant revenue stream in the gaming community.

Device and Platform Compatibility: The invention is designed to be compatible with a wide range of devices and Platforms, ensuring accessibility and ease of use for all users.

### 1) Web-Based Platform

A) Browser Compatibility: The Platform is accessible through all major web browsers, ensuring users can access the Platform on desktops and laptops regardless of their operating system.

B) Responsive Design: The web interface is designed to be responsive, providing an optimal user experience on both large screens and smaller devices such as tablets and smartphones.

### 2) Mobile Applications

A) iOS and Android Apps: The Platform offers dedicated mobile applications for iOS and Android devices, providing a seamless and optimized experience for mobile users.

B) Push Notifications: Mobile apps include push notifications to keep users informed about new content, Loot Box rewards, and other Platform updates.

### 3) Smart TVs and Streaming Devices

A) Smart TV Apps: The Platform can be integrated into smart TV Platforms, allowing users to browse and engage with UGC directly from their televisions.

B) Streaming Devices: The Platform is compatible with popular streaming devices such as Roku, Apple TV, and Amazon Fire TV, providing additional access points for users.

### 4) Voice Assistants and Smart Speakers

A) Voice Integration: The Platform can be integrated with voice assistants such as Amazon Alexa, Google Assistant, and Apple Siri, allowing users to interact with the Platform using voice commands.

B) Smart Speaker Compatibility: Users can engage with the Platform content and earn Tokenized Points through smart speakers, enhancing the overall accessibility of the Platform.

Future Expansions: The invention is designed with scalability in mind, allowing for future expansions and the inclusion of additional features and integrations.

### 1) Expanded Music Library

A) Additional Licensing: Secure licenses from more music labels and independent artists to expand the available music library, providing more options for Creators.

B) Exclusive Content: Partner with artists and labels to offer exclusive content and early releases through the invention, enhancing its appeal.

### 2) Enhanced AI Features

A) Advanced Personalization: Develop more sophisticated AI algorithms to provide even more personalized content recommendations and interactive features.

B) Sentiment Analysis: Implement advanced sentiment analysis tools to gauge user feedback and sentiment in real-time, allowing for continuous Platform improvement.

### 3) Augmented Reality (“AR”) and Virtual Reality (“VR”)

A) AR/VR Integration: Explore AR and VR technologies to create immersive experiences for Viewers and Creators, offering new ways to engage with UGC.

B) Virtual Events: Host virtual concerts, meet-and-greets, and other events within the invention, leveraging AR and VR technologies to enhance user experience.

### 4) Global Expansion

A) Multi-Language Support: Expand the Platform's language support to cater to a global audience, making the Platform accessible to users worldwide.

B) International Partnerships: Form partnerships with international Points Brands and Non-Points Brands to expand the reach and impact of the Platform.

Conclusion: The invention represents a groundbreaking innovation in the fields of digital content distribution, user engagement, and loyalty programs. By integrating tokenized music streaming points with user-generated content and leveraging advanced AI, the Platform addresses key challenges faced by music streaming services, content creators, and brands. The Platform's scalability and flexibility allow for future expansions including the integration of TV and film streaming points, air miles, hotel points, retail loyalty points, podcasts, news services, magazines, numerous retail services, clothing and fashion services, cosmetics providers, sports event providers, concert providers, theater providers, food services, and gaming points. The result is a dynamic and engaging ecosystem that enhances user experience, increases monetization opportunities, and drives customer loyalty across multiple industries.
1. A system for distributing tokenized music content access points from music streaming services to users engaging with user-generated content, comprising:
a) a music streaming service providing music content access points;
b) a platform configured to convert the music content access points into digital tokens;
c) a distribution module within the platform for distributing a portion of the digital tokens to viewers engaging with user-generated content;
d) a distribution module within the platform for distributing a portion of the digital tokens to creators that provide to the platform the user-generated content; and
e) a distribution module within the platform for distributing a portion of the digital tokens to the administrator of the platform.
2. The system of claim 1, wherein the digital tokens are stored in a secure database.
3. The system of claim 1, further comprising a method for redeeming tokenized points for music streaming access.
4. A system for distributing tokenized music content access points from music streaming services to users engaging with user-generated content, comprising:
a) users selecting tokenized points for redemption; and
b) a redemption module processing the tokenized points to provide users with access to music streaming content.
5. A system for distributing tokenized music content access points from music streaming services to users engaging with user-generated content, comprising:
a) a platform distributing variable reward virtual loot boxes containing tokenized points;
b) users earning variable reward loot boxes by engaging with user-generated content in a predetermined way; and
c) a mechanism for opening variable reward loot boxes to reveal tokenized points for collection by the user.
6. The system of claim 5, wherein the tokenized points from variable reward loot boxes are split equally between users, creators, and the platform.
7. A system for distributing tokenized music content access points from music streaming services to users engaging with user-generated content, comprising:
a) collecting data on user interactions with the platform;
b) analyzing the data to identify user preferences; and
c) generating personalized content recommendations based on the analysis.
8. The system of claim 7, further comprising real-time interactive AI features, including chatbots and virtual assistants, for enhancing user engagement.
9. The system of claim 7, wherein AI tools analyze content performance and provide insights to creators.
10. A system for distributing tokenized music content access points from music streaming services to users engaging with user-generated content, comprising:
a) an AI-based moderation engine to scan user-generated content;
b) identifying and flagging inappropriate or non-compliant content; and
c) a review process for handling flagged content.
11. A system for distributing tokenized music content access points from music
a) recording the distribution of tokenized points to users;
b) calculating the total value of tokenized points distributed to each user; and
c) storing the calculated values in a database.
12. A system for distributing tokenized music content access points from music streaming services to users engaging with user-generated content, comprising:
a) collecting data on tokenized point transactions;
b) generating IRS Form 1099-MISC and other necessary compliance reports; and
c) providing a user interface for accessing compliance reports.
13. A system for distributing tokenized music content access points from music streaming services to users engaging with user-generated content, comprising:
a) a blockchain ledger for recording transactions of tokenized points;
b) a verification system for ensuring the integrity of transactions; and
c) a mechanism for users to view their transaction history.
14. The system of claim 1, further comprising a marketplace for creators to offer their tokenized points for sale to brands seeking to re-distribute the same over the platform.
15. The system of claim 14, wherein a transaction module completes sales to brands.
16. The system of claim 1, further comprising AI-driven dynamic pricing for adjusting token prices based on demand.
17. The system of claim 1, further comprising:
a) a customization module for tailoring the user interface based on user preferences;
b) an AI engine for continually updating personalization options; and
c) a dashboard for users to manage their content and rewards.
18. The system of claim 1, further comprising AI-powered tools for user interaction prioritizations.
19. The system of claim 1, further comprising a feature for analyzing user feedback and sentiment.
20. The system of claim 1, further comprising compatibility with various devices, including web browsers, mobile apps, smart TVs, and streaming devices.
21. The system of claim 1, further comprising integration with voice assistants for interacting with the platform using voice commands.
22. The system of claim 1, further comprising capabilities for expanding the platform to include TV and film streaming points, air miles, hotel points, retail loyalty points, and gaming points.
23. A system for distributing tokenized music content access points from music streaming services to users engaging with user-generated content, wherein:
a) TV and film streaming access is also converted into tokenized points;
b) the access points are distributed through the platform's reward system; and
c) users redeem points for TV and film streaming content.
24. A system for distributing tokenized music content access points from music streaming services to users engaging with user-generated content, wherein:
a) air miles from airlines are also converted into tokenized points;
b) the access points are distributed through the platform's reward system; and
c) users redeem points for airline travel.
25. A system for distributing tokenized music content access points from music streaming services to users engaging with user-generated content, wherein:
a) hotel loyalty points are also converted into tokenized points;
b) the access points are distributed through the platform's reward system; and
c) users redeem points for hotel stays.
26. A system for distributing tokenized music content access points from music streaming services to users engaging with user-generated content, wherein:
a) retail loyalty points are also converted into tokenized points;
b) the access points are distributed through the platform's reward system; and
c) users redeem points for retail discounts.
27. A system for distributing tokenized music content access points from music streaming services to users engaging with user-generated content, wherein:
a) gaming platform points are also converted into tokenized points;
b) the access points are distributed through the platform's reward system; and
c) users redeem points for in-game content.
28. A system for distributing tokenized music content access points from music streaming services to users engaging with user-generated content, further comprising AR reward and interaction features to create immersive user experiences.
29. A system for distributing tokenized music content access points from music streaming services to users engaging with user-generated content, further comprising VR reward and interaction technologies for hosting virtual events within the platform.
31. The system of claim 1, further comprising capabilities for expanding the platform to include an individual Tokenized Point wallet sub-system where Tokenized Points may be unilaterally gifted from one Platform user's wallet to another Platform user's wallet when one user communicates directly with another user and offers such gift.
32. The system of claim 31, further comprising capabilities for expanding the platform to include an individual Tokenized Point wallet sub-system where Tokenized Points may be unilaterally gifted from one Platform user's wallet to another Platform user's wallet when one user communicates directly with another user and requests such gift
33. The system of claim 31, further comprising capabilities for expanding the platform to include an individual Tokenized Point wallet sub-system where Tokenized Points may be unilaterally gifted through offers or requests of users amongst themselves after one of the users to the gifting event is given permission to look into the wallet of the other user, such permission being temporary or permanent, and determines that that the other user's wallet has such number of Tokenized Points that the situation merits the user looking into such other user's wallet either giving Tokenized Points to them or requesting Tokenized Points from them.

Embodiments of the present disclosure may be implemented as an application loaded on a mobile device. A processor residing within the mobile device executes the application to perform the steps of the methods as described.

The description herein of the above-disclosed embodiments is provided to enable any person skilled in the art to make or use the present disclosure. Numerous modifications to these embodiments would be readily apparent to those skilled in the art, and the principles defined herein can be applied to other embodiments without departing from the spirit or scope of the present disclosure. Thus, the present disclosure is not intended to be limited to the embodiments shown herein but is to be accorded the widest scope consistent with the principal and novel features disclosed herein.

All features of each above-discussed example are not necessarily required in a particular embodiment of the present disclosure. Further, it is to be understood that the description and drawings presented herein are representative of the subject matter that is broadly contemplated by the present disclosure. It is further understood that the scope of the present disclosure fully encompasses other embodiments that may become obvious to those skilled in the art and that the scope of the present disclosure is accordingly limited by nothing other than the appended claims.

1. A system for tokenization, social distribution, and redemption of digital entitlements, comprising:
(a) a digital entitlement ingestion and tokenization engine configured to receive and escrow value-bearing digital entitlements from an entity;
(b) a token engine configured to generate transferable tokens from the entitlements with embedded redemption rules;
(c) a distribution module enabling third-party entities to purchase and airdrop the tokens to end users based on location or contextual triggers;
(d) a user wallet interface enabling the end users to collect, store, gift, and redeem the tokens;
(e) a social gifting module configured to allow the end users to transmit the tokens to other users subject to transfer rules; and
(f) an optional redemption bridge configured to un-tokenize the tokens that have been redeemed and initiate value transfer to accounts of the end users within the originating system.

2. The system of claim 1, wherein the tokenization engine allows merchants to define per-token redemption constraints including minimum purchase, time window, and product category.

3. The system of claim 1, wherein the digital entitlements are pre-funded and escrowed to ensure guaranteed redemption value.

4. The system of claim 1, wherein the token engine supports multiple formats including percentage discounts, access passes, or serialized codes.

5. The system of claim 1, wherein the airdrop is configured for visibility only during predefined time windows or spatial boundaries.

6. The system of claim 1, wherein the system supports parallel drops of identical or unique tokens across multiple physical or digital venues.

7. The system of claim 1, wherein the user wallet includes social visibility controls allowing users to set who may view or request specific tokens.

8. The system of claim 1, wherein activity data of the user wallet is anonymized and logged to generate first-party and zero-party data for analytics.

9. The system of claim 1, wherein gifted tokens retain redemption eligibility across multiple user transfers until redeemed or expired.

10. The system of claim 1, wherein a regifting loop terminates when a token is hoarded and not re-gifted for a specified period or redeemed.

11. The system of claim 1, wherein the end users who hoard tokens are flagged as likely high-affinity users for specific brands or campaigns.

12. The system of claim 1, wherein redemption is triggered by a user-initiated action and fulfilled through secure communication with the originating brand's system.

13. The system of claim 1, wherein un-tokenization results in deletion of the token from the system ledger and posting of value to the external system.

14. The system of claim 1, wherein all actions including token creation, sale, distribution, collection, transfer, and redemption are auditable and verifiable within a system ledger.

15. A method of enabling tokenized digital entitlement propagation and redemption, comprising the steps of:
(a) receiving a set of digital entitlements from a merchant;
(b) tokenizing the entitlements into standardized transferable assets with embedded use rules;
(c) enabling third-party sponsors to purchase and schedule drops of tokens;
(d) presenting the tokens to end users via geo-targeted or digital-contextual interfaces;
(e) allowing the end users to collect tokens into a digital wallet and optionally gift the tokens to peers;
(f) enabling redemption of the tokens by validating use conditions and executing untokenization into a digital entitlement form.

16. The method of claim 15, wherein the tokens are sold in bulk to third-party sponsors with tiered pricing based on campaign parameters.

17. The method of claim 15, wherein the tokens are distributed within virtual loot boxes that include randomized or tiered reward logic.

18. The method of claim 15, wherein the drops are initiated by sponsor-defined digital triggers including livestream embeds, QR scans, or event check-ins.

19. The method of claim 15, wherein the end users request tokens from peers, and the system facilitates such transfers based on embedded permissions.

20. The method of claim 15, wherein gifting events generate a traceable token propagation chain visible to sponsoring brands.
